(19) United States
(12) Patent Application Publication
(10) Pub. No.: US 2006/0269804 A1
(43) Pub. Date: Nov. 30, 2006

(54) Fuel cell power generation system method of detecting degree of deterioration of reformer therefor and fuel cell power generation method

(76) Inventors: Akinari Nakamura, Osaka (JP); Masataka Ozeki, Osaka (JP); Yoshikazu Tanaka, Kyoto (JP)

Correspondence Address: MCDERMOTT WILL & EMERY LLP, 600 13TH STREET, N.W., WASHINGTON, DC, 20005-3096, US

(21) Appl. No.: 10/568,731

(22) PCT Filed: Aug. 18, 2004
(86) PCT No.: PCT/JP04/12217

§ 371 Date: Feb. 21, 2006

(30) Foreign Application Priority Data
Aug. 19, 2003 (JP) 2003-295705

(51) Int. Cl. H01M 8/04; H01M 8/06; G05D 11/00

(52) U.S. Cl. 429/22; 429/19; 429/20; 700/286

(57) ABSTRACT

A fuel power generation system includes a reformer producing a hydrogen-rich fuel gas by reacting a raw material with vapor, a fuel cell generating power by using the fuel gas and an oxidizing gas, a raw material flow rate detecting instrument which detects the flow rate of the raw material supplied into said reformer, a water vapor flow rate detecting instrument which detects the flow rate of the water vapor supplied into said reformer, a fuel gas flow rate detecting instrument which detects the flow rate of the fuel gas produced in said reformer, and a deterioration degree detecting instrument which calculates the degree of deterioration of said reformer by comparing the calculated flow rate of the fuel gas calculated from the flow rate of the raw material and the flow rate of the water vapor with the detected flow rate of the fuel gas.

### TECHNICAL FIELD

The present invention relates to a fuel cell power generation system which generates electricity using a fuel cell, a method of detecting the degree of deterioration of a reformer therefore, a fuel cell power generation method, etc.

### BACKGROUND ART

Among related art fuel cell power generation systems, one makes deterioration diagnosis of a reformer by measuring the temperature of reformed gas (see, e.g., Reference 1 (JP-A-2000-268840)). FIG. 9 depicts a related art fuel cell power generation system disclosed in the above cited Reference 1.

In FIG. 9, when a shut-off valve 6 is opened, a city gas as a raw fuel is supplied into a desulfurizer 5 where it is then freed of rotten odor components causing the deterioration of catalyst. The city gas which has been freed of rotten odor components is mixed with a reforming water vapor, and then reformed in a reformer 2 to produce a hydrogen-rich fuel gas. The reformed gas produced contains from 10 to 15% of carbon monoxide, which causes the deterioration of catalyst, but is processed in a transformer 4 to convert carbon monoxide to carbon dioxide, and then supplied into a fuel cell 1 as a fuel gas having a reduced content of carbon monoxide.

In the fuel cell 1, the hydrogen-rich fuel gas and oxygen in the air are reacted with each other to generate electricity. During the starting of the fuel cell power generation system, a shut-off valve 7 is opened so that the city gas is combusted at a burner 3 to raise the temperature of the reformer 2. Except during the starting period, the shut-off valve 7 is closed so that the exhaust fuel gas discharged from the fuel cell 1 is combusted at the burner 3 to keep the temperature of the reformer 2 (at about 700° C. at maximum)

The temperature of the reformed gas in the reformer 2 is measured by a temperature sensor 9, and the temperature of reformed gas measured is then used to diagnose the state of deterioration of the reformer 2 at a deterioration diagnosing portion 10.

The above related art fuel cell power generation system uses the temperature of reformed gas as an instrument which diagnoses the state of deterioration of the reformer 2, but this has the following problems.

In some detail, the fuel cell power generation system of FIG. 9 disclosed in the above cited Reference 1 is a 200 kW phosphoric acid type fuel cell power generation system. A phosphoric acid type fuel cell power generation system having such an output scale normally generates electricity at a constant output as great as its output (200 kW). In the case where the output is as great as mentioned above, some fluctuation of the amount of the reformed gas produced by the reformer 2 and the temperature of the reformed gas in the reformer 2 can be tolerated.

However, in a small-sized fuel cell power generation system having an output scale as small as about 1 kW and a household fuel cell power generation system which performs output fluctuation, temperature control of the maintenance of the temperature of the reformer must be effected more precisely.

Referring to the reason, the system having an output scale of about 1 kW comprises a reformer having a very small size as compared with that of the reformer 2 disclosed in the above cited Reference 1 and hence a great susceptibility to the effect of temperature fluctuation. Further, the system which performs output fluctuation is also susceptible to temperature fluctuation caused by the fluctuation of the supplied amount of city gas and the amount of reforming water vapor with output fluctuation.

Therefore, in the small-sized fuel cell power generation system having an output scale as small as about 1 kW and the household fuel cell power generation system which performs output fluctuation, it is necessary that stable supply of fuel gas be effected to control the temperature of reformed gas at a constant value so that the reforming reaction occurs at a conversion ratio of methane. In other words, such a fuel cell power generation system controls the temperature of reformed gas at a constant value and can very difficultly diagnose the state of deterioration of the reformer from the temperature of reformed gas.

### DISCLOSURE OF THE INVENTION

The present invention has an object of providing a fuel cell power generation system and a deterioration degree detecting method of a reformer therefore, a fuel cell power generation system using same, and a fuel cell power generation method, etc., capable of effecting the detection of the deterioration of the reformer while controlling the temperature of reformed gas at a constant temperature, taking into account the above problems.

In order to solve the above object, the 1^{st} aspect of the present invention is a fuel cell power generation system comprising:

a reformer producing a hydrogen-rich fuel gas by reacting a raw material with water vapor;

a fuel cell generating power by using the fuel gas and an oxidizing gas;

a raw material flow rate detecting instrument which detects the flow rate of the raw material supplied into said reformer;

a water vapor flow rate detecting instrument which detects the flow rate of the water vapor supplied into the reformer;

a fuel gas flow rate detecting instrument which detects the flow rate of the fuel gas produced in said reformer; and

a deterioration degree detecting instrument which calculates the degree of deterioration of said reformer by comparing the calculated flow rate of the fuel gas calculated from the flow rate of the raw material and the flow rate of the water vapor with the detected flow rate of the fuel gas detected.

The 2^{nd} aspect of the present invention is the fuel cell power generation system according to the 1^{st} aspect of the present invention, wherein said deterioration degree detecting instrument calculates the flow rate of the fuel gas produced when said reformer is not deteriorated as the calculated flow rate.

The 3^{rd} aspect of the present invention is a fuel cell power generation system comprising:

a reformer of producing a hydrogen-rich fuel gas by reacting with a raw material and water vapor;

a fuel cell of generating power by using the fuel gas and an oxidizing gas;

a raw material flow rate detecting instrument which detects the flow rate of the raw material supplied into said reformer;

a water vapor flow rate detecting instrument which detects the flow rate of the water vapor supplied into said reformer;

a differential pressure detecting instrument which detects the difference of pressure of the fuel gas between two predetermined points on the flow path of the fuel gas; and

a deterioration degree detecting instrument which calculates the degree of deterioration of said reformer by comparing the calculated value of difference of pressure of fuel gas between the two predetermined points calculated from the flow rate of the raw material and the flow rate of the water vapor with the detected value of difference of pressure of fuel gas between the two predetermined points.

The 4^{th} aspect of the present invention is a fuel cell power generation system according to the 3^{rd} aspect of the present invention, wherein said deterioration degree detecting instrument calculates the difference of pressure of the fuel gas produced when said reformer is not deteriorated between the two predetermined points as the calculated value.

The 5^{th} aspect of the present invention is a fuel cell power generation system comprising:

a reformer producing a hydrogen-rich fuel gas by reacting a raw material with water vapor;

a fuel cell generating power by using the fuel gas and an oxidizing agent gas;

a raw material flow rate detecting instrument which detects the flow rate of the raw material supplied into said reformer;

a water vapor flow rate detecting instrument which detects the flow rate of the water vapor supplied into said reformer;

a concentration detecting instrument which detects the concentration of water vapor or the concentration of raw material in the fuel gas; and

a deterioration degree detecting instrument which calculates the degree of deterioration of said reformer by comparing the calculated value of the concentration of water vapor contained in the fuel gas calculated from the flow rate of the raw material and the flow rate of the water vapor with the concentration of water vapor or the concentration of raw material detected.

The 6^{th} aspect of the present invention is a fuel cell power generation system according to the 5^{th} aspect of the present invention, wherein said deterioration degree detecting instrument calculates the concentration of water vapor or the concentration of raw material contained in the fuel gas produced when said reformer is not deteriorated as the calculated value.

The 7^{th} aspect of the present invention is the fuel cell power generation system according to any one of the 1^{st}, the 3^{rd} and the 5^{th} aspects of the present invention, further comprising a reformer heating instrument which raises the reaction temperature of said reformer according to the degree of deterioration detected by said deterioration degree detecting instrument so that the flow rate of the fuel gas is not less than a value at which power generation of said fuel cell is possible.

The 8^{th} aspect of the present invention is the fuel cell power generation system according to any one of the 1^{st, the} 3^{rd} and the 5^{th} aspects of the present invention, further comprising a water vapor flow rate controlling instrument which controls the flow rate of the water vapor according to the degree of deterioration detected by said deterioration degree detecting instrument so that the flow rate of the water vapor increases to cause the flow rate of the fuel gas to be not less than a value at which power generation of said fuel cell is possible.

The 9^{th} aspect of the present invention is the fuel cell power generation system according to the 8^{th} aspect of the present invention, further comprising a raw material flow rate controlling instrument which controls the flow rate of the raw material to increase according to the degree of deterioration detected by said deterioration degree detecting instrument so that the flow rate of the fuel gas is not less than a value at which power generation of said fuel cell is possible.

The 10^{th} aspect of the present invention is the fuel cell power generation system according to any one of the 1^{st}, the 3^{rd} and the 5^{th} aspects of the present invention, further comprising a generated power output control instrument which controls the generated power output according to the degree of deterioration detected by said deterioration degree detecting instrument so that the generated power output decreases to not greater than a value at which power generation of said fuel cell is possible.

The 11^{th} aspect of the present invention is a fuel cell power generation system according to the 5^{th} aspect of the present invention, wherein said water vapor concentration detecting instrument detects the water vapor concentration by detecting the dew point of the fuel gas flowing through the flow path of the fuel gas.

The 12^{th} aspect of the present invention is a fuel cell power generation system according to the 5^{th} aspect of the present invention, wherein said water vapor concentration detecting instrument detects the water vapor concentration by detecting the relative humidity of the fuel gas flowing through the flow path of the fuel gas.

The 13^{th} aspect of the present invention is a fuel cell power generation system according to the 5^{th} aspect of the present invention, wherein a water flow rate meter for measuring the amount of water which is supplied to produce the water vapor to be supplied into said reformer is provided instead of said water vapor flow rate detecting instrument, and said deterioration degree detecting instrument calculates the degree of deterioration of said reformer on the basis of the supplied amount of water measured by said water flow rate meter instead of the flow rate of the water vapor.

The 14^{th} aspect of the present invention is the fuel cell power generation system according to any one of the 1^{st}, the 3^{rd} and the 5^{th} aspects of the present invention, comprising a life diagnosing instrument which determines the falling rate of the degree of deterioration based on the degree of deterioration of said reformer and the power generation time to calculate the period to reach the lower limit of the degree of deterioration of said reformer at which power generation of said fuel cell is made possible.

The 15^{th} aspect of the present invention is the fuel cell power generation system according to any one of the 1^{st, the} 3^{rd} and the 5^{th} aspects of the present invention, wherein said deterioration degree detecting instrument uses conversion ratio of methane as the degree of deterioration of said reformer.

The 16^{th} aspect of the present invention is a method of detecting the degree of deterioration of a reformer of a fuel cell system comprising:

a raw material flow rate detecting step of detecting the flow rate of a raw material supplied into said reformer producing a hydrogen-rich fuel gas by reacting a raw material with water vapor;

a water vapor flow rate detecting step of detecting the flow rate of the water vapor supplied into said reformer;

a fuel gas flow rate detecting step of detecting the flow rate of the fuel gas produced in said reformer; and

a deterioration degree detecting step of calculating the degree of deterioration of said reformer by comparing the calculated flow rate of the fuel gas calculated from the flow rate of the raw material and the flow rate of the water vapor with the detected flow rate of the fuel gas detected.

The 17^{th} aspect of the present invention is a method of detecting the degree of deterioration of a reformer of a fuel cell power generation system comprising:

a raw material flow rate detecting step of detecting the flow rate of a raw material supplied into said reformer of producing a hydrogen-rich fuel gas by reacting with a raw material and water vapor;

a water vapor flow rate detecting step of detecting the flow rate of the water vapor supplied into said reformer;

a fuel gas flow rate detecting step of detecting the flow rate of the fuel gas produced in said reformer;

a differential pressure detecting step of detecting the difference of pressure of the fuel gas between two predetermined points on the flow path of the fuel gas; and

a deterioration degree detecting step of calculating the degree of deterioration of said reformer by comparing the calculated value of difference in pressure of fuel gas between the two predetermined points calculated from the flow rate of the raw material and the flow rate of the water vapor with the detected value of difference in pressure of fuel gas between the two predetermined points.

The 18^{th} aspect of the present invention is a method of detecting the degree of deterioration of a reformer of a fuel cell power generation system comprising:

a raw material flow rate detecting step of detecting the flow rate of the raw material supplied into said reformer producing a hydrogen-rich fuel gas by reacting a raw material with water vapor;

a water vapor flow rate detecting step of detecting the flow rate of the water vapor supplied into the reformer;

a concentration detecting step of detecting the concentration of water vapor or the concentration of raw material in said fuel gas; and

a deterioration degree detecting step of calculating the degree of deterioration of the reformer by comparing the calculated value of concentration of water vapor contained in the fuel gas calculated from the flow rate of the raw material and the flow rate of the water vapor with the detected water vapor concentration or the concentration of raw material concentration.

The 19^{th} aspect of the present invention is a fuel cell power generation method which executes power generation of a fuel cell using a fuel gas by making the use of the method of detecting the degree of deterioration of the reformer of the fuel cell power generation system according to any one of the 16^{th} to the 18^{th} aspects of the present invention, comprising:

a reformer heating step of raising the reaction temperature of said reformer according to the degree of deterioration detected by said deterioration degree detecting step so that the flow rate of the fuel gas is not less than a value at which power generation of the fuel cell is made possible.

The 20^{th} aspect of the present invention is a fuel cell power generation method which executes power generation of a fuel cell using a fuel gas by making the use of the method of detecting the degree of deterioration of the reformer of the fuel cell power generation system according to any one of the 16^{th} to the 18^{th} aspects of the present invention, comprising:

a water vapor flow rate controlling step of controlling the flow rate of the water vapor according to the degree of deterioration detected by said deterioration degree detecting step so that the flow rate of the water vapor increases to cause the flow rate of the fuel gas to be not less than a value at which power generation of said fuel cell is made possible.

The 21^{st} aspect of the present invention is a fuel cell power generation method which executes power generation of a fuel cell using fuel gas by making the use of the method of detecting the degree of deterioration of the reformer of the fuel cell power generation system according to any one of the 16^{th} to the 18^{th} aspects of the present invention, comprising:

a raw material flow rate controlling step of controlling the flow rate of the raw material to increase according to the degree of deterioration detected by said deterioration degree detecting step so that the flow rate of the fuel gas is not less than a value at which power generation of said fuel cell is made possible.

The 22^{nd} aspect of the present invention is a fuel cell power generation method of executing power generation of a fuel cell using the fuel gas by making the use of the method of detecting the degree of deterioration of the reformer of the fuel cell power generation system according to any one of the 16^{th} to the 18^{th} aspects of the present invention, comprising:

a generated electric power output controlling step of controlling the generated power output according to the degree of deterioration detected by said deterioration degree detecting step so that the generated power output decreases to not greater than a value that allows power generation of said fuel cell.

The 23^{rd} aspect of the present invention is a program of allowing a computer to perform as said deterioration degree detecting unit of the fuel cell power generation system according to the 1^{st} aspect of the present invention of calculating the degree of deterioration of said reformer by comparing the calculated flow rate of fuel gas calculated from the flow rate of the raw material and the flow rate of the water vapor with the detected flow rate of fuel gas detected.

The 24^{th} aspect of the present invention is a program of allowing a computer to perform as a deterioration degree detecting instrument of a fuel cell power generation system according to the 3^{rd} aspect of the present invention of calculating the degree of deterioration of said reformer by comparing the calculated value of difference in pressure of fuel gas between the two predetermined points calculated from the flow rate of the raw material and the flow rate of the water vapor with the detected value of difference in pressure of the fuel gas between the two predetermined points.

The 25^{th} aspect of the present invention is a program of allowing a computer to perform as a deterioration degree detecting instrument of a fuel cell power generation system according to the 5^{th} aspect of the present invention of calculating the degree of deterioration of said reformer by comparing the calculated value of the concentration of water vapor or the concentration of raw material contained in the fuel gas calculated from the flow rate of the raw material and the flow rate of the water vapor with the concentration of the water vapor detected.

The 26^{th} aspect of the present invention is a program of allowing a computer to perform as said reformer heating instrument of the fuel cell power generation system according to the 7^{th} aspect of the present invention of raising the reaction temperature of said reformer according to the degree of deterioration detected by said deterioration degree detecting instrument so that the flow rate of fuel gas is not less than a value at which the power generation of said fuel cell is possible.

The 27^{th} aspect of the present invention is a program of allowing a computer to perform as a water vapor flow rate controlling instrument of the fuel cell power generation system according to the 8^{th} aspect of the present invention of controlling the flow rate of the water vapor according to the degree of deterioration detected by said deterioration degree detecting instrument so that the flow rate of the water vapor increases to be not less than a value at which power generation of said fuel cell is possible.

The 28^{th} aspect of the present invention is a program of allowing a computer to perform as a raw material flow rate increasing instrument of a fuel cell power generation system according to the 9^{th} aspect of the present invention of controlling the flow rate of the raw material to increase according to the degree of deterioration detected by said deterioration degree detecting instrument so that the flow rate of the fuel gas is not less than a value at which power generation of said fuel cell is possible.

The 29^{th} aspect of the present invention is a program of allowing a computer to perform as a generated electric power output controlling instrument of the fuel cell power generation system according to the 10^{th} aspect of the present invention of controlling the generated power output according to the degree of deterioration detected by said deterioration degree detecting instrument so that the generated electric power output decreases to not greater than a value at which power generation of said fuel cell is possible.

The 30^{th} aspect of the present invention is a recording medium having a program according to any one of the 23^{rd} to the 29^{th} aspects of the present invention carried thereon, which can be processed by a computer.

In accordance with the present invention, there can be provided a fuel cell power generation system and a method of detecting the degree of deterioration of the reformer therefor, and a fuel cell power generation method, etc., capable of detecting the deterioration of a reformer while controlling the temperature of reformed gas at a constant temperature.

### BRIEF DESCRIPTION OF THE DRAWINGS

FIG. 1 is a configurational diagram illustrating a fuel cell power generation system according to Embodiment 1.

FIG. 2 is a configurational diagram illustrating a fuel cell power generation system according to Embodiment 2.

FIG. 3 is a configurational diagram illustrating a fuel cell power generation system according to Embodiment 3.

FIG. 4 is a configurational diagram illustrating a fuel cell power generation system according to Embodiment 4.

FIG. 5 is a flow chart illustrating the operation of detecting deterioration degree in Embodiment 1.

FIG. 6 is a flow chart illustrating the operation of detecting deterioration degree in Embodiment 2.

FIG. 7 is a flow chart illustrating the operation of detecting deterioration degree in Embodiment 3.

FIG. 8 is a flow chart illustrating the operation of life diagnosis in Embodiment 4.

FIG. 9 is a configurational diagram illustrating a related art fuel cell power generation system.

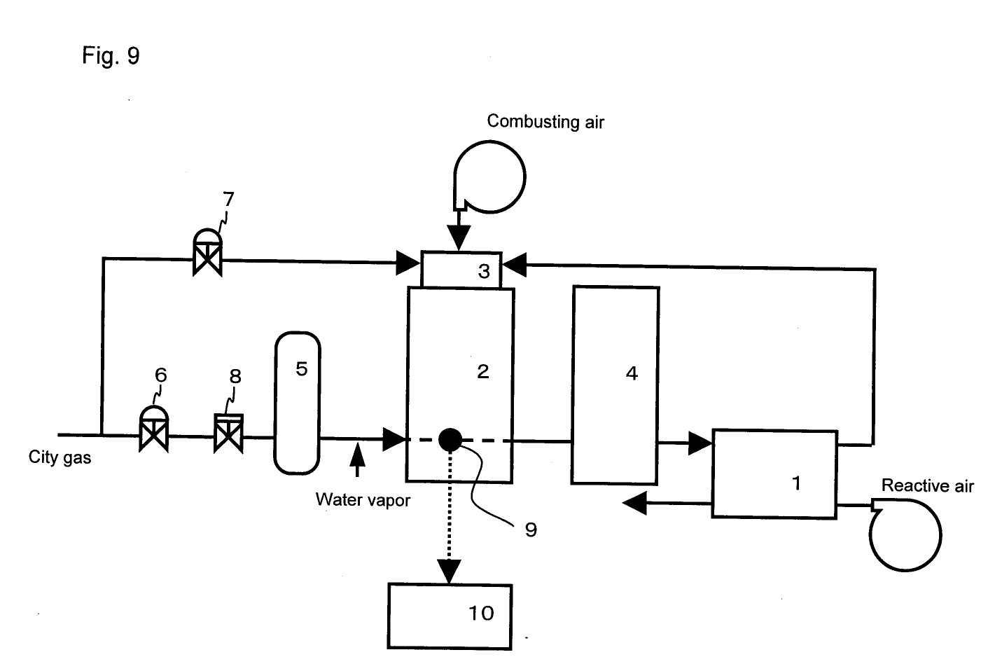

FIG. 10 is a configurational diagram illustrating a fuel cell power generation system according to Embodiment 5.

FIG. 11 is a flow chart illustrating the operation of the fuel cell power generation system according to Embodiment 5.

FIG. 12 is a configurational diagram illustrating a fuel cell power generation system according to Embodiment 6.

FIG. 13 is a flow chart illustrating the operation of the fuel cell power generation system according to Embodiment 6.

FIG. 14 is a configurational diagram illustrating a fuel cell power generation system according to Embodiment 7.

FIG. 15 is a flow chart illustrating the operation of the fuel cell power generation system according to Embodiment 7.

FIG. 16 is a configurational diagram illustrating a fuel cell power generation system according to Embodiment 8.

FIG. 17 is a flow chart illustrating the operation of the fuel cell power generation system according to Embodiment 8.

FIG. 18 is a diagram illustrating the operation of the fuel cell power generation system according to Embodiment 8.

FIG. 19 is a graph illustrating the state of operation of an example of the fuel cell power generation system of the present invention.

FIG. 20 is a graph illustrating the state of operation of a comparative example of the fuel cell power generation system of the present invention.

### DESCRIPTION OF REFERENCE AND NUMERALS AND SIGNS

1, 11 Fuel cell
2, 12 Reformer
3, 13 Burner
4 Transformer
5, 15 Desulfurizer
6, 7, 16, 17 Shut-off valve
8, 18, 28 Flow rate control valve
9 Temperature sensor
10 Deterioration diagnosing portion
14 Carbon monoxide remover
19 Raw material gas flow rate meter
20 Water vapor flow rate meter
21 Fuel gas flow rate meter
22 Deterioration degree detecting unit
23 Differential pressure meter
24 Water vapor concentration meter
25 Life diagnosing unit
26 Burner controlling instrument
27 DC-AC inverter
29 Flow rate control valve-controlling instrument
30 Input current-controlling instrument
31 Inverter-controlling instrument

### BEST MODE FOR CARRYING OUT THE INVENTION

Embodiment of implementation of the present invention will be described in connection with the drawings.

### Embodiment 1

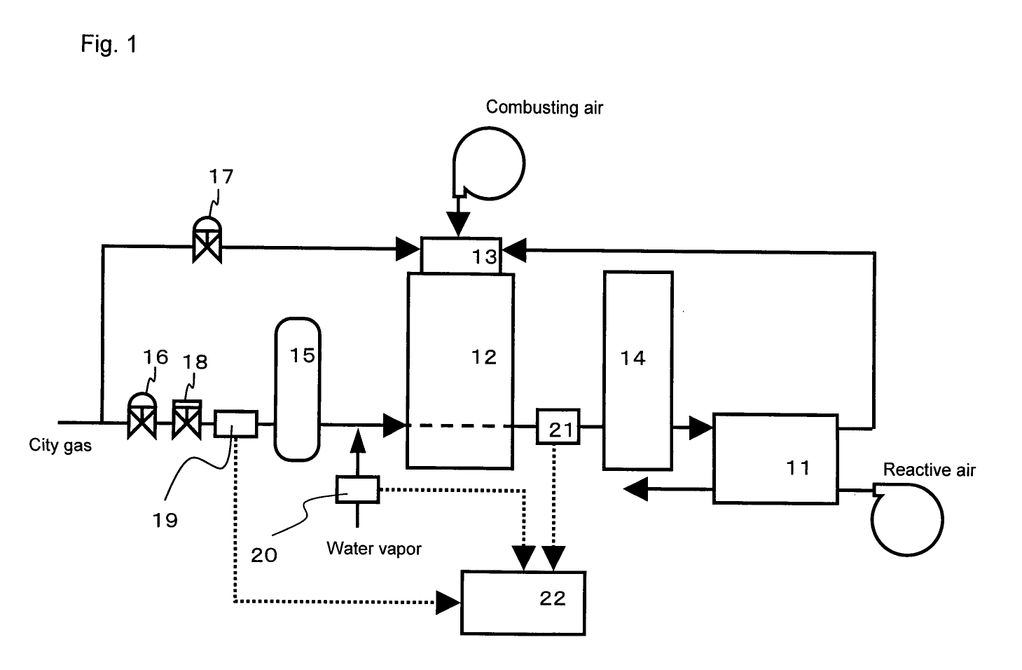

FIG. 1 is a configurational diagram illustrating a fuel cell power generation system according to Embodiment 1 of the present invention. The arrow represented by dotted line in FIG. 1 indicates the flow of signal detected.

The fuel cell power generation system according to Embodiment 1 of the present invention comprises a fuel cell 11 which generates electric power by using a fuel gas and an oxidizing agent gas. There is also provided a reformer 12 which produces a hydrogen-rich fuel gas by water vapor-reforming a city gas which is a raw material gas. There is further provided a burner 13 which keeps the temperature of the reformer 12 by combusting a city gas as a gas to be combusted or exhaust fuel gas discharged from the fuel cell 11.

There are further provided a carbon monoxide remover 14 which causes the reduction of carbon monoxide contained in the fuel gas produced in the reformer 12 and a desulfurizer 15 which removes rotten odor components contained in the city gas.

There are further provided a shut-off value 16 and a shut-off valve 17 which execute supply/shut-off of raw material gas and gas to be combusted. There is further provided a flow rate control valve 18 which controls the flow rate of raw material gas. There are further provided a raw material gas flow rate meter 19 which detects the flow rate of raw material gas, a water vapor flow rate meter 20 which detects the flow rate of water vapor which is being supplied into the reformer 12 and a fuel gas flow rate meter 21 which detects the flow rate of fuel gas at the outlet of the reformer 12.

There is further provided a deterioration degree detecting unit 22 which detects the degree of deterioration of the reformer 12 upon the reception of signal from the raw material gas flow rate meter 19, the water vapor flow rate meter 20 and the fuel gas flow rate meter 21.

The raw material gas, the raw material gas flow rate meter 19, the water vapor flow rate meter 20, the fuel gas flow rate meter 21 and the deterioration degree detecting unit 22 each are a specific example of the raw material, the raw material flow rate detecting instrument, the water vapor flow rate detecting instrument, the fuel gas flow rate detecting instrument and the deterioration degree detecting instrument of the present invention, respectively. Further, the carbon monoxide remover 14 is thought to be either or both of a transformer which executes shift reaction using water vapor and a carbon monoxide selective oxidizer which causes oxidation reaction using oxygen.

Next, the operation of the fuel cell power generation system according to Embodiment 1 will be described, whereby a method of detecting the degree of deterioration of the reformer of the fuel cell power generation system of the present invention will be also described. In the following embodiments, too, the method of detecting the degree of deterioration of the reformer of the fuel cell power generation system of the present invention will be described.

The city gas which has been supplied as a raw material gas from the exterior of the system is freed of rotten odor components at the desulfurizer 15, and then supplied into the reformer 12 with water vapor. The raw material gas is reformed with water vapor in the reformer 12, processed at the carbon monoxide remover 14 to reduce its carbon monoxide concentration, and then supplied into the fuel cell 11 as a hydrogen-rich fuel gas.

On the other hand, reactive air which is an oxidizing agent gas has been supplied into the fuel cell 11 where the fuel gas and the reactive air undergo electrochemical reaction to perform the generation of electricity. A dc current generated by the fuel cell 11 is converted to ac power by a DC-AC inverter (not shown), and then supplied to an external load. Further, the exhaust fuel gas containing hydrogen which was not used in power generation in the fuel cell 11 is supplied into the burner 13 where it is then used as a fuel cell of heating the reformer 12. During the starting of the fuel cell power generation system, the shut-off valve 17 is opened so that the city gas is combusted in the burner 13 to raise the temperature of the reformer 12. Further, the flow rate of the raw material gas to be supplied is controlled by the flow rate control valve 18.

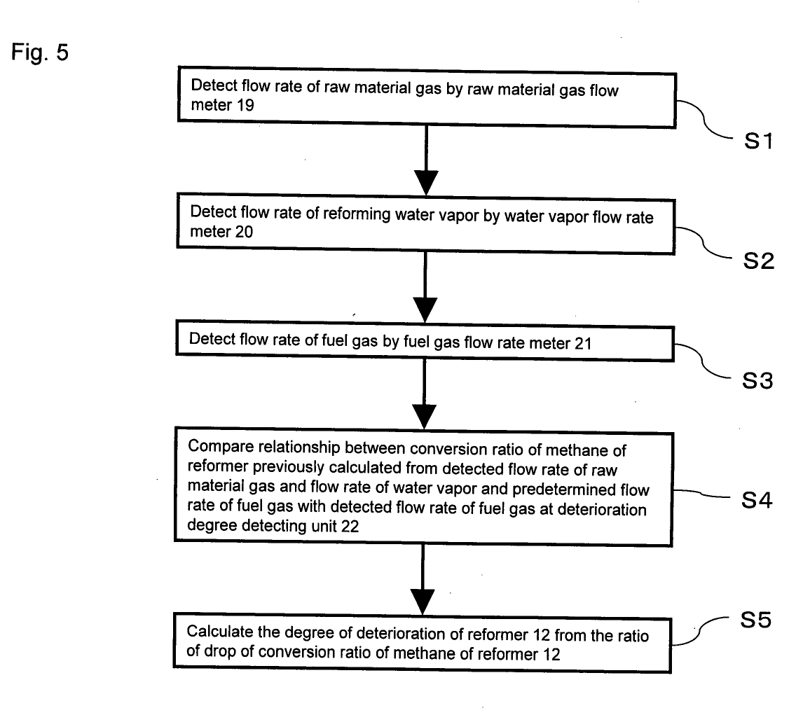

Next, the operation of detection of the degree of deterioration of the reformer 12 will be described in connection with FIGS. 1 and 5. FIG. 5 is a flow chart illustrating an operating method to be used in the detection of the degree of deterioration of the reformer 12.

Firstly, the flow rate of raw material gas is detected by the raw material gas flow rate meter 19 (Step S1). Subsequently, the flow rate of reforming water vapor is detected by the water vapor flow rate meter 20 (Step S2). Further, the flow rate of fuel gas produced by the reformer 12 is detected by the fuel gas flow rate meter 21 (Step S3). The deterioration degree detecting unit 22 receives the various flow rate detection signals and then calculates the relationship between the conversion ratio of methane in the reformer 12 and the predetermined flow rate of fuel gas from the flow rate of the raw material gas and the flow rate of water vapor detected. The deterioration degree detecting unit 22 then compares the relationship between conversion ratio of methane and predetermined flow rate of fuel gas calculated with the actually detected flow rate of fuel gas (Step S4). From the ratio of drop of the conversion ratio of methane in the reformer 12 obtained is calculated the degree of deterioration of the reformer 12 (Step S5).

The principle of the operation of calculation of the degree of deterioration of the reformer 12 of the fuel cell power generation system according to Embodiment 1 is as follows.

In the reformer 12, a reforming reaction represented by (chemical formula 1) occurs to produce hydrogen from methane.
CH₄+2H₂O→4H₂+CO₂ (Chemical formula 1)

In the case where the conversion ratio of methane is 100%, 4 NL/min of hydrogen and 1 NL/min of carbon dioxide are produced from 1 NL/min of methane and 2 NL/min of water vapor. In other words, the total flow rate increases from 3 NL/min to 5 NL/min.

Further, in the case where the conversion ratio of methane is 50%, 2 NL/min of hydrogen and 0.5 NL/min of carbon dioxide are produced from 1 NL/min of methane and 2 NL/min of water vapor, but and 0.5 NL/min of methane and 1 NL/min of water vapor are left unused. In this case, the total flow rate increases from 3 NL/min to 4 NL/min, but the rise of the total flow rate is smaller than that in the case where the conversion ratio of methane is 100%.

The operation of detection of the degree of deterioration in the reformer 12 of Embodiment 1 makes the use of the change of output flow rate with respect to input flow rate of the same composition with the change of conversion ratio of methane, that is, the fact that when the conversion ratio of methane decreases, the rise of output flow rate (flow rate of hydrogen-rich fuel gas produced in the reformer 12) with respect to input flow rate of the same composition (sum of the flow rate of methane and the flow rate of water vapor) decreases. It is natural that the city gas as a raw material gas includes ethane, butane, propane, etc., besides methane, but a similar principle can be applied to components other than methane. Further, of course, water vapor is supplied into the reformer 12 in an amount of not smaller than the theoretical ratio of (chemical formula 1), but the calculation and comparison are made taking into account this factor as well.

In other words, in accordance with the constitution and the operating method of the fuel cell power generation system according to Embodiment 1, the raw material gas flow rate meter 19, the water vapor flow rate meter 20, the fuel gas flow rate meter 21 and the deterioration degree detecting unit 22 are provided, making it possible to compare the relationship between the conversion ratio of methane characteristic to the reformer 12 and the predetermined flow rate of fuel gas previously calculated from the flow rate of raw material gas and the flow rate of water vapor and the predetermined flow rate of fuel gas with the actually detected flow rate of fuel gas and calculate the degree of deterioration of the reformer 12 from the ratio of drop of the conversion ratio of methane of the reformer 12.

While the fuel cell power generation system of Embodiment 1 has been described with reference to the case where as the degree of deterioration of the reformer 12 there is used “conversion ratio of methane”, which is more desirable, the method of using another type of degree of deterioration may be carried out also by “previously determining experimentally the relationship between the flow rate of the fuel gas and the concentration of hydrogen in the fuel gas and comparing such data with the flow rate of raw material and the flow rate of water vapor”.

Further, while the fuel cell power generation system of Embodiment 1 has been described with reference to the case where the fuel gas flow rate meter 21 is disposed between the reformer 12 and the carbon monoxide remover 14, the fuel gas flow rate meter 21 maybe similarly disposed between the carbon monoxide remover 14 and the fuel cell 11 because the conversion ratio of methane is determined by the properties of the reformer 12. Moreover, while the fuel cell power generation system of Embodiment 1 has been described with reference to the constitution that “water required for reforming reaction is supplied in the form of water vapor and the flow rate of water vapor supplied is measured by the water vapor flow rate meter 20”, the constitution that “water vapor required for reforming reaction is supplied in the form of water (liquid) and the flow rate of water supplied is measured by a water flow rate meter” may be similarly employed. In this case, however, an evaporating portion of evaporating water is needed downstream from the water flow rate meter.

Further, while the fuel cell power generation system of Embodiment 1 has been described with reference to the case where the deterioration degree detecting unit 22 performs calculation and comparison taking into account also the fact that water vapor is supplied into the reformer 12 in an amount of not smaller than the theoretical ratio of (chemical formula 1) as shown by the flow chart in FIG. 5, the conversion ratio of methane may be determined by calculating the flow rate of the fuel gas as an ideal value on the basis of only the flow rate of the raw material and the flow rate of water vapor as measured value and the theoretical ratio without taking into account the actual operating conditions of the reformer 12 and then comparing it with the measured value of flow rate of fuel gas detected. In this case, it is advantageous in that the calculation method of the deterioration degree detecting unit 22 can be more simplified, making it possible to enhance general-purpose properties.

### Embodiment 2

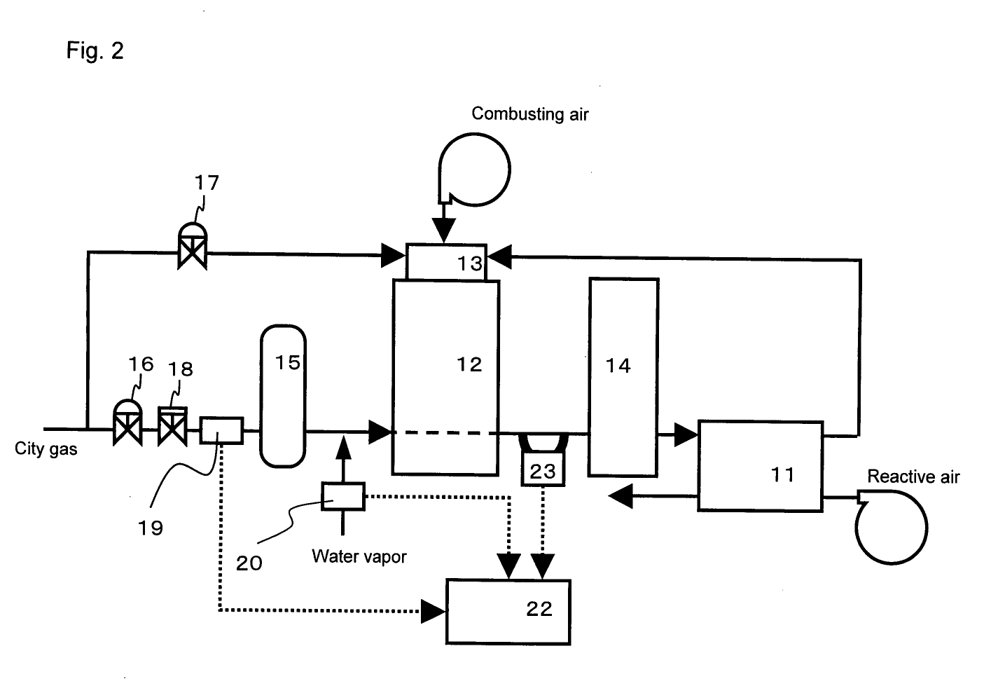

FIG. 2 is a configurational diagram illustrating the fuel cell power generation system according to Embodiment 2 of the present invention. However, where the components have the same members and function as those of FIG. 1, the same numbers are given and the description thereof will be omitted. The arrow represented by dotted line in FIG. 2 indicates the flow of signal detected.

In the fuel cell power generation system according to Embodiment 2, a differential pressure meter 23 is provided instead of the fuel gas flow rate meter 21 of FIG. 1 on the flow path downstream from the reformer 12 to which the fuel gas of the reformer 12 is discharged. Further, the operation of the fuel cell power generation system according to Embodiment 2 is the same as that of Embodiment 1 and will not be described. The differential pressure meter 23 is an example of the differential pressure detecting instrument of the present invention.

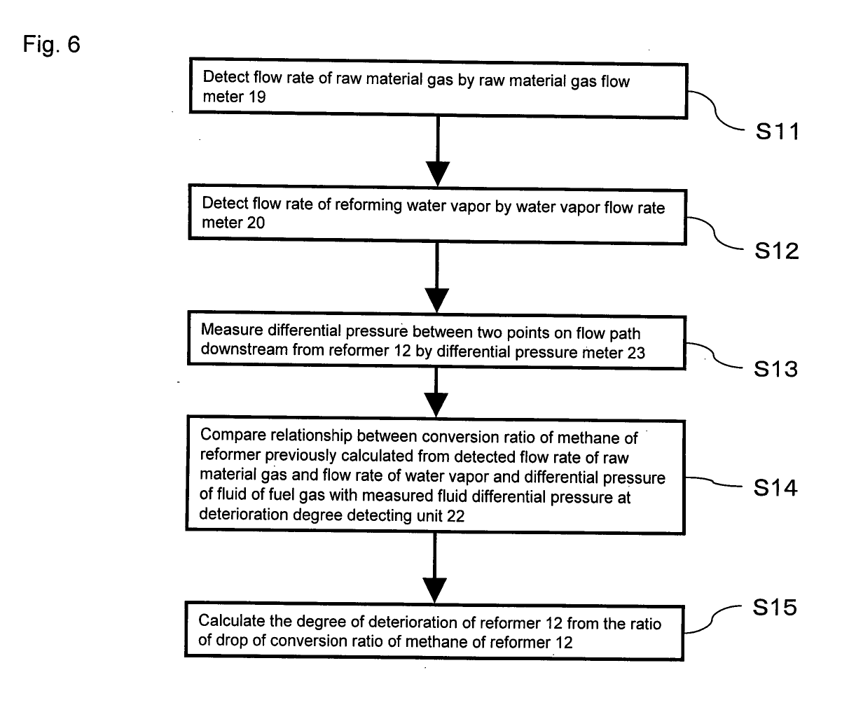

Next, the operation of detection of the degree of deterioration of the reformer 12 of the fuel cell power generation system according to Embodiment 2 will be described in connection with FIGS. 2 and 6. FIG. 6 is a flow chart illustrating the operating method to be used in the detection of the degree of deterioration of the reformer 12.

Firstly, the flow rate of raw material gas is detected by the raw material gas flow meter 19 (Step S11). Subsequently, the flow rate of reforming water vapor is detected by the water vapor flow rate meter 20 (Step S12). Further, the difference of pressure of the fuel gas produced by the reformer 12 between two predetermined points on the flow path downstream from the reformer is measured by the differential pressure meter 23 (Step S13). The deterioration degree detecting unit 22 receives the various flow rate detection signal and differential pressure measurement signal and then calculates the relationship between the conversion ratio of methane in the reformer 12 and the fluid differential pressure on the downstream flow path from the flow rate of the raw material gas and the flow rate of water vapor detected. The deterioration degree detecting unit 22 then compares the relationship between conversion ratio of methane and fluid differential pressure on the downstream flow path calculated with the actually detected fluid differential pressure on the downstream flow path (Step S14). From the ratio of drop of the conversion ratio of methane of the reformer 12 obtained is calculated the degree of deterioration of the reformer 12 (Step S15).

The operation of calculation of the degree of deterioration in the reformer 12 of the fuel cell power generation system of Embodiment 2 makes the use of the fact that the fluid pressure loss over the measurement section changes with the change of flow rate due to the change of conversion ratio of methane, that is, the fact that the difference of pressure of fuel gas decreases when the reformer 12 is deteriorated. The differential pressure meter 23 used in Embodiment 2 is advantageous in that it allows the cost reduction as compared with the fuel gas flow rate meter 21 used in Embodiment 1, stable operation at high temperatures and accurate measurement even on pulsating fluid.

While the above constitution has been described with reference to the case where the deterioration degree detecting unit 22 performs calculation and comparison taking into account also the fact that water vapor is supplied into the reformer 12 in an amount of not smaller than the theoretical ratio of (chemical formula 1), the conversion ratio of methane may be determined by calculating the difference of pressure of fuel gas as an ideal value on the basis of only the flow rate of the raw material and the flow rate of water vapor as measured value and the theoretical ratio without taking into account the actual operating conditions of the reformer 12 and then comparing it with the measured value of difference of pressure of fuel gas detected.

### Embodiment 3

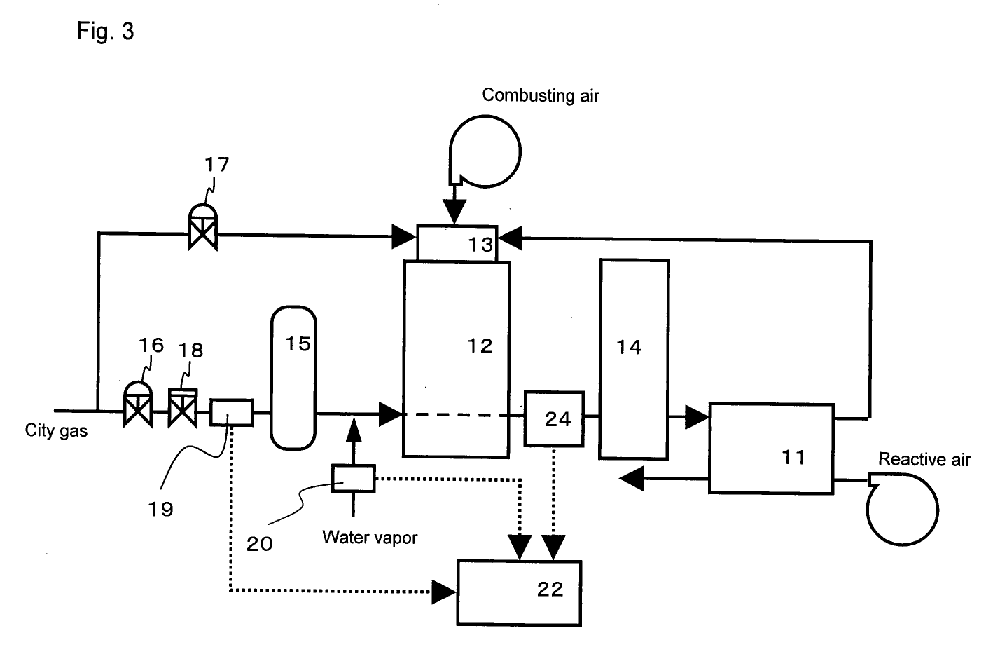

FIG. 3 is a configurational diagram illustrating the fuel cell power generation system according to Embodiment 3 of the present invention. However, where the components have the same members and function as those of FIG. 1, the same numbers are given and the description thereof will be omitted. The arrow represented by dotted line in FIG. 3 indicates the flow of signal detected. Further, the operation of the fuel cell power generation system according to Embodiment 3 is the same as that of Embodiment 1 and will not be described.

The fuel cell power generation system according to Embodiment 3 comprises a water vapor concentration meter 24 provided on the fuel gas flow path between the reformer 12 and the carbon monoxide remover 14 instead of the fuel gas flow rate meter 21 of FIG. 1. The water vapor concentration meter 24 is an example of the concentration detecting instrument of the present invention.

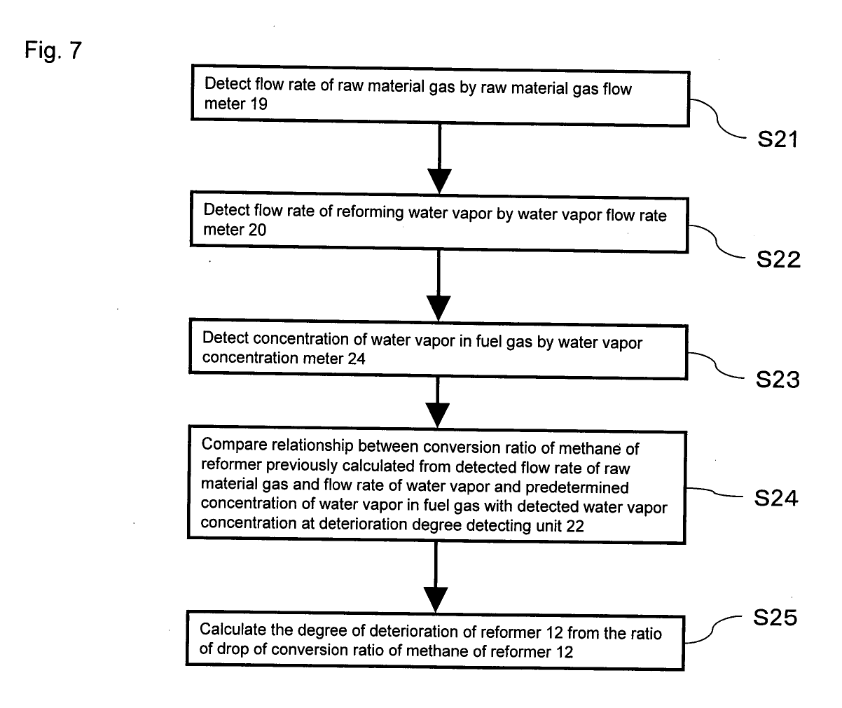

Next, the operation of detection of the degree of deterioration of the reformer 12 of the fuel cell power generation system according to Embodiment 3 will be described in connection with FIGS. 3 and 7. FIG. 7 is a flow chart illustrating the operating method to be used in the detection of the degree of deterioration of the reformer 12.

Firstly, the flow rate of raw material gas is detected by the raw material gas flow rate meter 19 (Step S21). Subsequently, the flow rate of reforming water vapor is detected by the water vapor flow rate meter 20 (Step S22).

Further, the concentration of water vapor in the fuel gas produced by the reformer 12 is detected by the water vapor concentration meter 24 (Step S23). The deterioration degree detecting unit 22 receives the flow rate detection signal and water vapor concentration signal and then calculates the relationship between the conversion ratio of methane in the reformer 12 and the predetermined concentration of water vapor in the fuel gas from the flow rate of the raw material gas and the flow rate of water vapor detected.

The deterioration degree detecting unit 22 then compares the relationship between conversion ratio of methane and predetermined concentration of water vapor in fuel gas calculated with the actually detected concentration of water vapor in the fuel gas (Step S24). From the ratio of drop of conversion ratio of methane of the reformer 12 obtained is calculated the degree of deterioration of the reformer 12 (Step S25).

The principle of the operation of calculation of the degree of deterioration in the reformer 12 of the fuel cell power generation system of Embodiment 3 is as follows.

In the reformer 12, a reforming reaction represented by (chemical formula 1) occurs to produce hydrogen from methane.

In the case where the conversion ratio of methane is 100%, 4 NL/min of hydrogen and 1 NL/min of carbon dioxide are produced from 1 NL/min of methane and 2 NL/min of water vapor. In other words, the concentration of water vapor in the fuel gas is 0%.

Further, in the case where the conversion ratio of methane is 50%, 2 NL/min of hydrogen and 0.5 NL/min of carbon dioxide are produced from 1 NL/min of methane, but 2 NL/min of water vapor and 0.5 NL/min of methane, and 1 NL/min of water vapor are left unused. In this case, the concentration of water vapor in the fuel gas is 25%.

The operation of calculation of the degree of deterioration in the reformer 12 of Embodiment 3 makes use of the fact that the above change of conversion ratio of methane causes the change of the concentration of water vapor in the output fuel gas with respect to the input flow rate of the same composition. It is natural that the city gas as a raw material gas includes ethane, butane, propane, etc., besides methane, but a similar principle can be applied to components other than methane. Further, of course, water vapor is supplied into the reformer 12 in an amount of not smaller than the theoretical ratio of (chemical formula 1), but the calculation and comparison are made taking into account this factor as well.

In other words, in accordance with the constitution and the operating method of the fuel cell power generation system according to Embodiment 2, the raw material gas flow rate meter 19, the water vapor flow rate meter 20, the water vapor concentration meter 24 and the deterioration degree detecting unit 22 are provided, making it possible to compare the relationship between the conversion ratio of methane and the predetermined concentration of water vapor previously calculated from the flow rate of raw material gas and the flow rate of water vapor with the actually detected water vapor concentration and calculate the degree of deterioration of the reformer 12 from the ratio of drop of the conversion ratio of methane of the reformer 12.

While the fuel cell power generation system of Embodiment 3 has been described with reference to the case where as the degree of deterioration of the reformer 12 there is used “conversion ratio of methane”, which is more desirable, the method of using another type of degree of deterioration may be carried out also by “previously determining experimentally the relationship between the concentration of water vapor in the fuel gas and the concentration of hydrogen in the fuel gas and comparing such data with the flow rate of the raw material and the flow rate of water vapor”.

Further, while the fuel cell power generation system of Embodiment 3 has been described with reference to the case where the water vapor concentration meter 24 is disposed between the reformer 12 and the carbon monoxide remover 14, the water vapor concentration meter 24 may be similarly disposed between the carbon monoxide remover 14 and the fuel cell 11 because the conversion ratio of methane is determined by the properties of the reformer 12. Moreover, while the fuel cell power generation system of Embodiment 3 has been described with reference to the constitution that “water required for reforming reaction is supplied in the form of water vapor and the flow rate of water vapor supplied is measured by the water vapor flow rate meter 20”, the constitution that “water vapor required for reforming reaction is supplied in the form of water (liquid) and the flow rate of water supplied is measured by a water flow rate meter” may be similarly employed. In this case, however, an evaporating portion of evaporating water is needed downstream from the water flow rate meter.

Further, as an instrument which detects the concentration of water vapor contained in the fuel gas produced by the reformer 12 there may be used a dew point meter. In this case, it is advantageous in that the water content can be accurately detected.

Further, as an instrument which detects the concentration of water vapor contained in the fuel gas produced by the reformer 12 there may be used a hygrometer of measuring relative humidity. In this case, it is advantageous in that the system can be provided at reduced cost in a compact form.

Further, while the deterioration degree detecting unit 22 has been described with reference to the case where calculation and comparison are made taking into account also the fact that water vapor is supplied into the reformer 12 in an amount of not smaller than the theoretical ratio of (chemical formula 1) as shown by the flow chart of FIG. 7, the conversion ratio of methane may be determined by calculating the flow rate of the fuel gas as an ideal value on the basis of only the flow rate of the raw material and the flow rate of water vapor as measured value and the theoretical ratio without taking into account the actual operating conditions of the reformer 12 and then comparing it with the measured value of the flow rate of fuel gas detected.

Moreover, while the foregoing description has been made with reference to the case where the degree of deterioration of the reformer 12 is determined by detecting the concentration of water vapor contained in the fuel gas produced by the reformer 12 and then comparing it with the relationship between conversion ratio of methane and predetermined concentration of water vapor previously calculated from the flow rate of raw material gas and the flow rate of water vapor, the concentration detecting instrument of the present invention may be realized as an instrument comprising a gas analyzer or the like of directly detecting the concentration of raw material gas such as methane contained in the fuel gas. In this case, the concentration of raw material gas can be directly obtained, making it possible to calculate the conversion ratio of methane at a higher accuracy.

### Embodiment 4

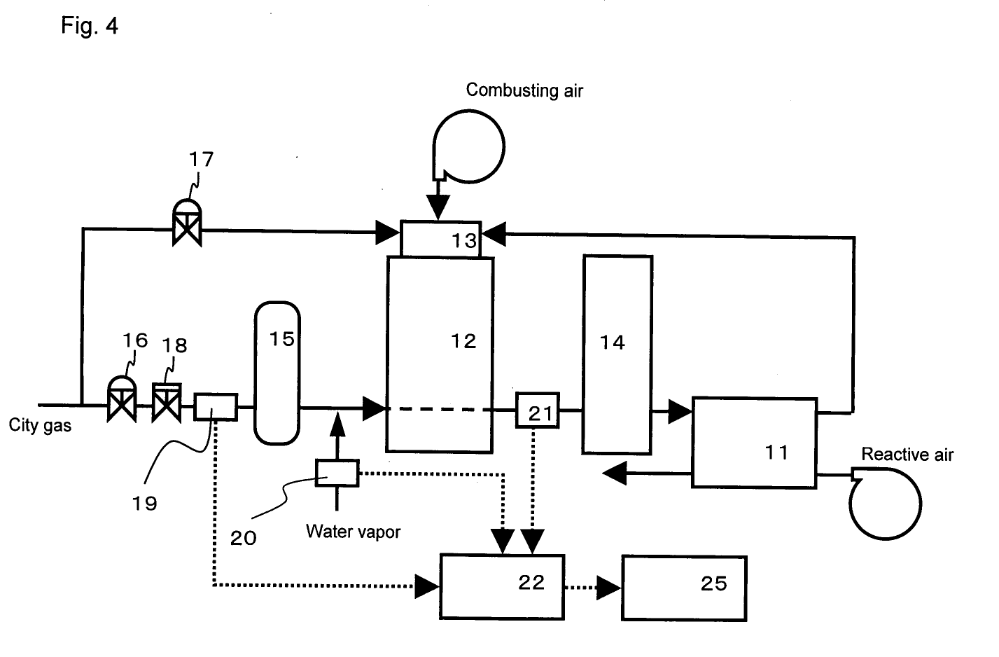

FIG. 4 is a configurational diagram illustrating the fuel cell power generation system according to Embodiment 4 of the present invention. However, where the components have the same members and function as those of FIG. 1, the same numbers are given and the description thereof will be omitted. The arrow represented by dotted line in FIG. 4 indicates the flow of signal detected or calculated.

In the fuel cell power generation system according to Embodiment 4, there is further provided a life diagnosing unit 25 of judging the time of replacement of the reformer 12 on the basis of the degree of deterioration calculated in the deterioration degree calculating unit 22 in addition to the constitution of the fuel cell power generation system of Embodiment 1 shown in FIG. 1. The life diagnosing unit 25 is an example of the life diagnosing instrument of the present invention. The operation of the fuel cell power generation system according to Embodiment 4 is the same as that of Embodiment 1 and will not be described.

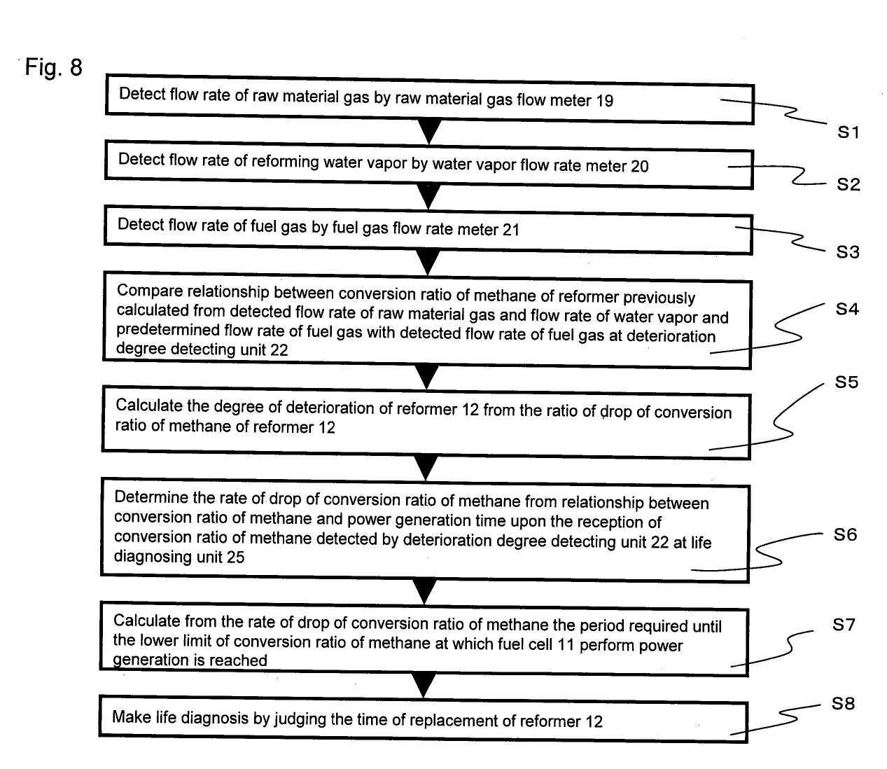

The operation of life diagnosis of judging the time of replacement of the reformer 12 of the fuel cell power generation system according to Embodiment 4 will be described in connection with FIGS. 4 and 8. FIG. 8 is a flowchart illustrating the operating method in the judgment of the time of replacement of the reformer 12. Steps S1 to S5 shown in FIG. 8 are the same as those of Embodiment 1 described in connection with FIG. 5 and will not be described.

The life diagnosing unit 25 receives the conversion ratio of methane calculated by the deterioration degree detecting unit 22 at Step S5 described with reference to Embodiment 1 in connection with FIG. 5 and determines the falling rate of the conversion ratio of methane from the relationship between conversion ratio of methane and power generation time (Step S6). From the falling rate of conversion ratio of methane is then calculated the period to reach the lower limit of conversion ratio of methane at which the power generation of the fuel cell 11 is made possible (Step S7). The time of replacement of the reformer 12 is then judged to make life diagnosis (Step S8).

In other words, in accordance with the constitution and operating method of the fuel cell power generation system according to Embodiment 4, the life diagnosing unit 25 is further provided in addition to the fuel cell power generation system of Embodiment 1, making it possible to determine the falling rate of the conversion ratio of methane from the relationship between conversion ratio of methane and the time of power generation, judge the time of replacement of the reformer 12 and make life diagnosis.

While the fuel cell power generation system of Embodiment 4 has been described in a form developed from the fuel cell power generation system of Embodiment 1 and its operating method, it may be embodied also in a form developed from the fuel cell power generation system of other embodiments and its operating method.

As can be seen in the foregoing description, the fuel cell power generation system of the present invention which controls the temperature of the reformed gas at a constant value can instantaneously and continuously detect the deterioration of the reformer in situ to judge the time of replacement of the reforming catalyst.

### Embodiment 5

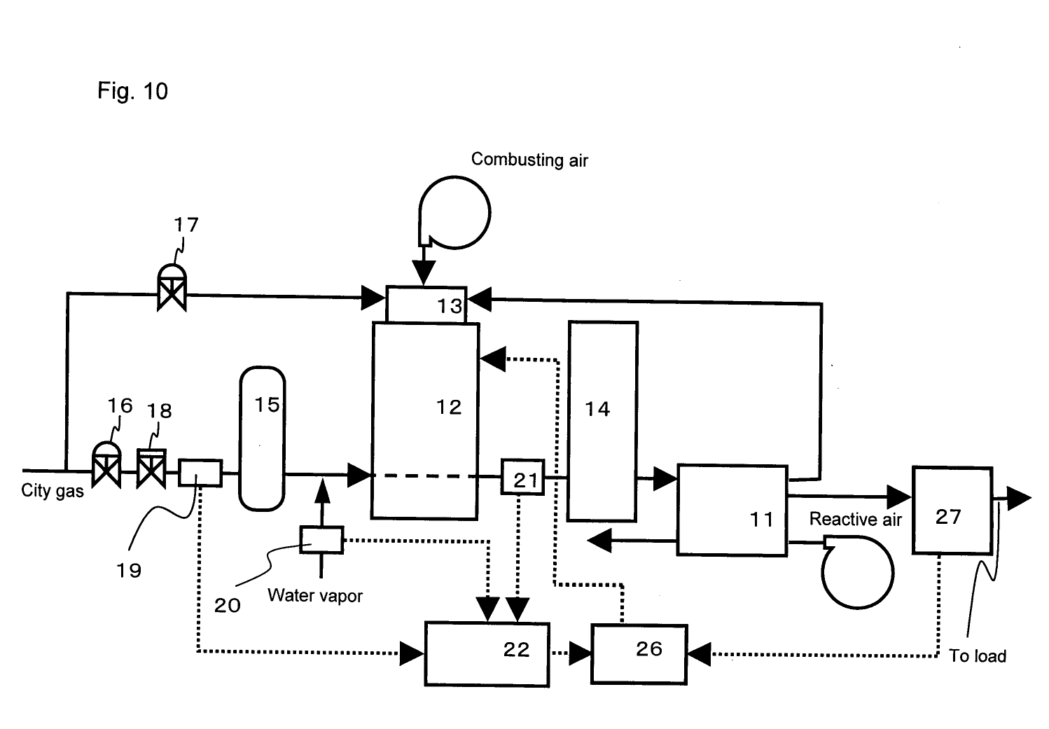

FIG. 10 is a configurational diagram illustrating the fuel cell power generation system according to Embodiment 5 of the present invention. However, where the components have the same members and function as those of FIG. 1, the same numbers are given and the description thereof will be omitted. The arrow represented by dotted line in FIG. 10 indicates the flow of signal detected or calculated.

The fuel cell power generation system according to Embodiment 5 improves the decrease of output power attributed to the fall off of voltage of the fuel cell 11 as a result of the decrease of the content of hydrogen in the fuel gas caused by the deterioration of the reformer 12. In general, the fuel cell 11 is composed of a plurality of fuel gas-permeable cells which are stacked in the direction of flow of the hydrogen-rich fuel gas, but since, due to the deterioration of the reformer, hydrogen in the fuel gas is consumed in the cells disposed upstream of the flow of fuel gas, causing little electromotive force to be generated downstream, the voltage of the fuel cell 11 composed of a series combination of cells drops. Further, the decrease in the flow rate of fuel gas causes the drop of the generated amount of electric current and hence the drop of the amount of electric power obtained.

The fuel systems of the present and the following embodiment are designated to eliminate the above problems arising from the deterioration of the reformer 12 and further comprises a burner controlling instrument 26 which controls the operation of the burner 13 upon the reception of the degree of deterioration obtained by the deterioration degree detecting unit 22 in addition to the constitution of the fuel cell power generation system of Embodiment 1 shown in FIG. 1. The burner controlling instrument 26 and the burner 13 each are an example of the reformer heating instrument of the present invention. A DC-AC inverter 27 of supplying ac power from the fuel cell 11 to a load which is not shown is also shown.

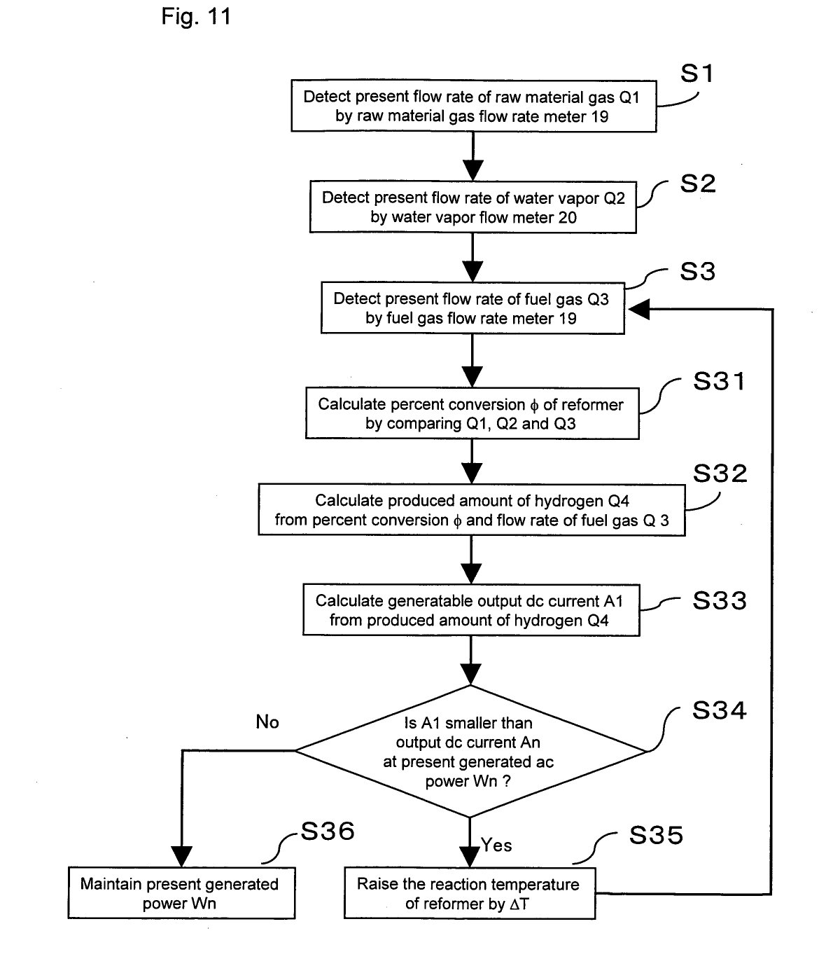

The operation of the fuel cell power generation system according to Embodiment 5 of raising the temperature of the reformer 12 upon the reception of the degree of deterioration of the reformer 12 will be described in connection with FIGS. 10 and 11 and the fuel cell power generation method of the present invention will be described as well. In the following embodiments, too, the fuel cell power generation method will be described.

FIG. 11 is a flow chart illustrating the operating method to be used in the operation of raising the temperature of the reformer 12.

Since Steps S1 to S3 shown in FIG. 11 are the same as those of Embodiment 1 described in connection with FIG. 5 and S31 is a step comprising S4 and S5 in combination, they will not be described.

Subsequently, upon the reception of conversion ratio of methane φ as deterioration degree obtained at the deterioration degree judging unit 22 and the flow rate of fuel gas Q3, the burner controlling instrument 26 calculates the produced hydrogen amount Q4 which the reformer 12 can produce at present (S32). Further, the output dc current A1 which the fuel cell 1 can generate is calculated on the basis of this produced hydrogen amount Q4 (S33).

Further, judgment is made to see if A1 is smaller than the output dc current An at the present generated ac power Wn by referring to the operating conditions of DC-AC inverter 27 (S34). In the case where An is greater than A1, the burner controlling instrument 26 controls the burner 13 so that the caloric force of the burner 13 is raised, e.g., by increasing the supplied amount of city gas such that the reaction temperature of the reformer 12 is raised by ΔT, and the process then returns to S3 (S35). When the temperature of the reformer 12 rises, the conversion ratio of methane turns to enhancement, causing a good fuel gas to be supplied into the fuel cell 11 and making it possible to obtain a proper voltage.

On the other hand, in the case where An is not greater than A1, the burner controlling instrument 26 controls the burner so that the reaction temperature of the reformer remains the same. The present generated ac power Wn is maintained (S36).

### Embodiment 6

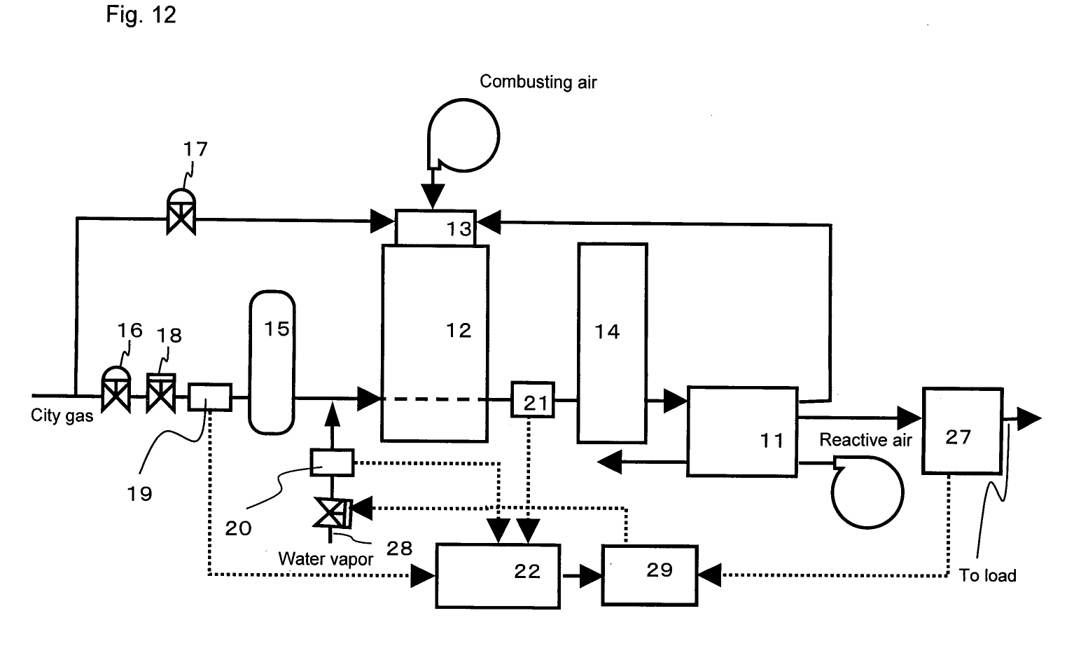

FIG. 12 is a configurational diagram illustrating the fuel cell power generation system according to Embodiment 6 of the present invention. However, where the components have the same members and function as those of FIG. 1, the same numbers are given and the description thereof will be omitted. The arrow represented by dotted line in FIG. 12 indicates the flow of signal detected or calculated.

The fuel system of the present embodiment further comprises a flow rate control valve 28 of varying the supplied amount of water vapor and a flow rate control valve-controlling instrument 29 which controls the operation of the flow rate control valve 28 upon the reception of the degree of deterioration at the deterioration degree detecting unit 22 in addition to the constitution of the fuel cell power generation system of Embodiment 1 shown in FIG. 1. The flow rate control valve 28 and the flow rate control valve-controlling unit 29 each are an example of the constitution of the water vapor flow rate-controlling instrument of the present invention. As in the case of Embodiment 5, a DC-AC inverter 27 of supplying ac power from the fuel cell 11 to a load which is not shown is shown as well.

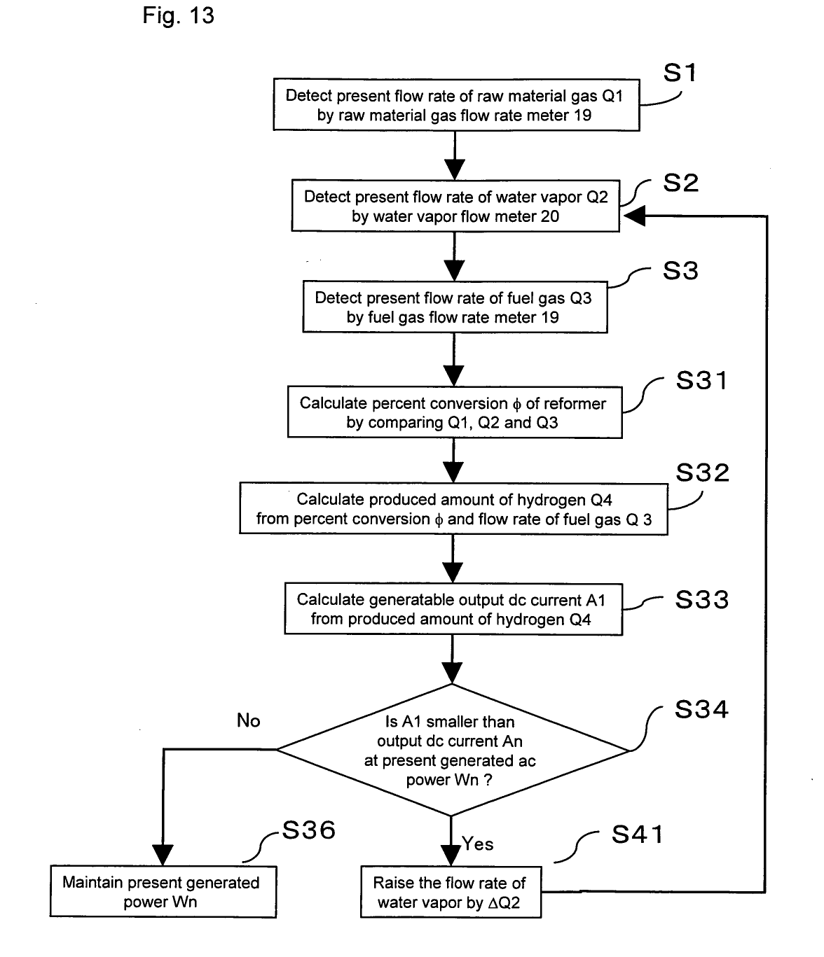

The operation of the reformer 12 of the fuel cell power generation system according to Embodiment 6 will be described in connection with FIGS. 12 and 13. FIG. 13 is a flow chart illustrating the operating method to be used in the operation of supplying water vapor into the reformer 12.

Steps S1 to S3 shown in FIG. 13 are the same as those of Embodiment 1 described in connection with FIG. 5, S31 is a step comprising S4 and S5 in combination, and S32 to S34 and S36 are as shown in the flow chart of FIG. 11 of Embodiment 5. In other words, in the present embodiment, upon the reception of conversion ratio of methane φ as deterioration degree obtained at the deterioration degree judging unit 22 and the flow rate of fuel gas Q3, the flow rate control valve-controlling instrument 29 calculates the produced hydrogen amount Q4 which the reformer 12 can generate at present (S32). Further, the output dc current A1 which the fuel cell 1 can generate is calculated on the basis of this produced hydrogen amount Q4 (S33).

Further, judgment is made to see if A1 is smaller than the output dc current An at the present generated ac power Wn by referring to the operating conditions of DC-AC inverter 27 (S34). In the case where An is greater than A1, the flow rate control valve-controlling instrument 29 controls the flow rate control valve 28 so that the opening of the flow rate control valve 28 is raised to increase the supplied amount of water vapor to the reformer 12 by ΔQ2 (S41). When the supplied amount of water vapor to the reformer 12 rises, the equilibrium of reforming reaction shifts to the status production of hydrogen, enhancing the conversion ratio of methane, to make the conversion ratio of methane turn to enhancement, causing a good fuel gas to be supplied into the fuel cell 11 and making it possible to obtain a proper voltage.

On the other hand, in the case where An is not greater than A1, the flow valve control valve-controlling instrument 29 causes the opening of the flow rate control valve 28 to remain the same. The present generated ac power Wn is maintained (S36).

### Embodiment 7

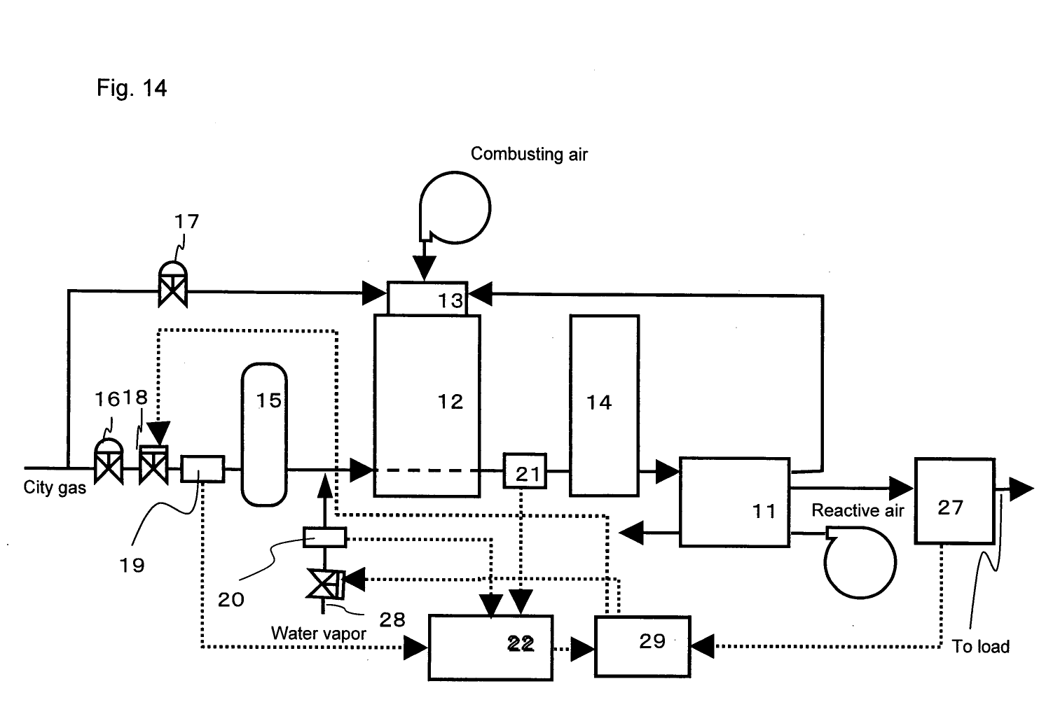

FIG. 14 is a configurational diagram illustrating the fuel cell power generation system according to Embodiment 7 of the present invention. However, where the components have the same members and function as those of FIGS. 1 and 12, the same numbers are given and the description thereof will be omitted. The arrow represented by dotted line in FIG. 12 indicates the flow of signal detected or calculated.

The fuel cell power generation system of the present invention differs from Embodiment 7 in that the flow rate control valve-controlling unit instrument further controls the flow rate control valve 18 of city gas in addition to the fuel cell power generation system of Embodiment 6 shown in FIG. 12.

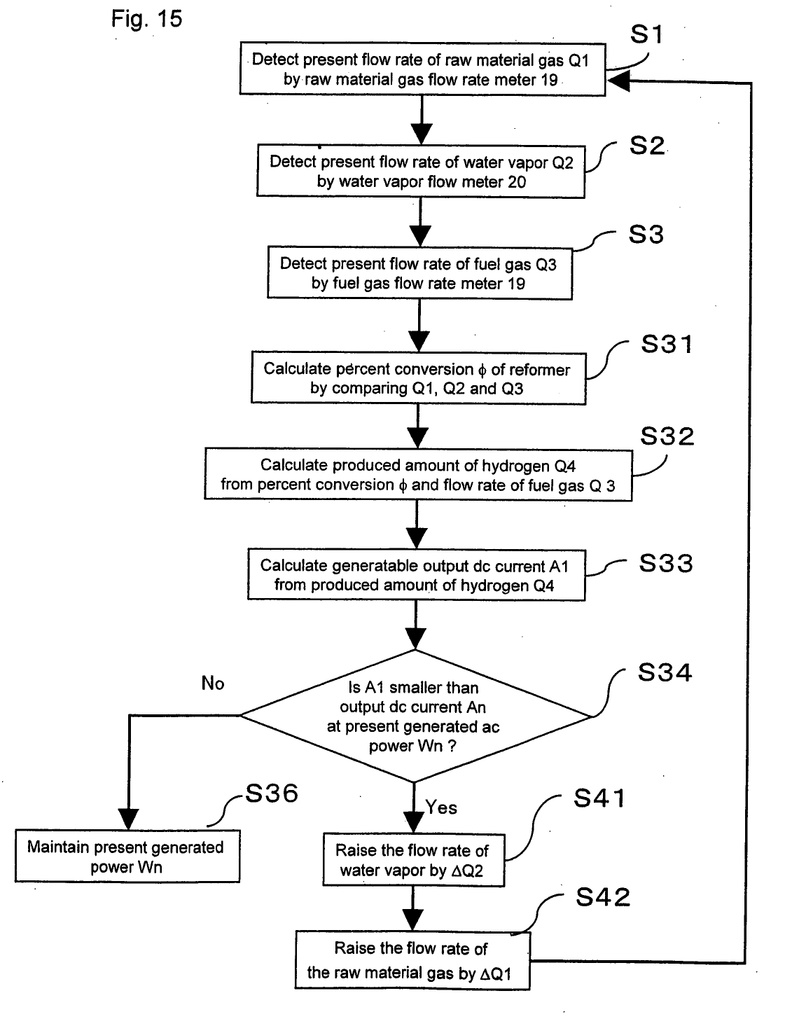

The operation of the fuel cell power generation system according to Embodiment 7 of raising the reaction temperature of the reformer 12 upon the reception of the degree of deterioration of the reformer 12 will be described in connection with FIGS. 14 and 15. FIG. 15 is a flow chart illustrating the operating method in the operation of supplying water vapor and city gas as raw material gas into the reformer 12. However, the fuel cell power generation system of the present embodiment will be described focusing the different points with the description of the same steps as in Embodiment 6 omitted. In other words, in the case where it has been judged at S34 that the present output dc current An is greater than the generatable output dc current A1, the flow rate control valve-controlling instrument 29 controls the flow rate control valve 28 so that the opening of the flow rate control valve 28 is raised to increase the flow rate of water vapor to the reformer 12 by ΔQ2 (S41) and then controls the flow rate control valve 28 so that the opening of the flow rate control valve 28 is raised to increase the flow rate of city gas to the reformer 12 by ΔQ1 (S42).

The reason why the control of the flow rate of water vapor is followed by the control of the flow rate of the city gas is as follows. When the flow rate of raw material gas is singly raised at first, there occur disadvantages, e.g., (1) the dew point of fuel gas falls, making it likely that the life of the fuel cell 11 can be reduced, (2) when the ratio of water vapor in the fuel gas is reduced, carbon in methane (CH₄) separates out inside the reformer 12, making it likely that the performance of the catalyst in the reformer 12 can be deteriorated, (3) the capability of the carbon monoxide remover 14 of removing carbon monoxide (CO) is deteriorated to raise the content of CO in the fuel gas, making it likely that the fuel cell 11 can be poisoned with CO. Accordingly, in Embodiment 6 and the present embodiment, neither single control of the supplied amount of raw material gas nor control of the rise of the supplied amount of raw material gas prior to control of the rise of the supplied amount of water vapor is executed.

In accordance with the above control, the supplied amount of city gas to the reformer 12 is raised in addition to the supplied amount of water vapor. In this manner, the same principle as in Embodiment 6, combined with the enhancement of conversion ratio of methane, causes the rise of the absolute amount of raw material gas and water vapor required for reforming reaction and hence the total amount of fuel gas generated, making it possible to supply a necessary amount of city gas into the fuel cell 11 and obtain a proper voltage.

### Embodiment 8

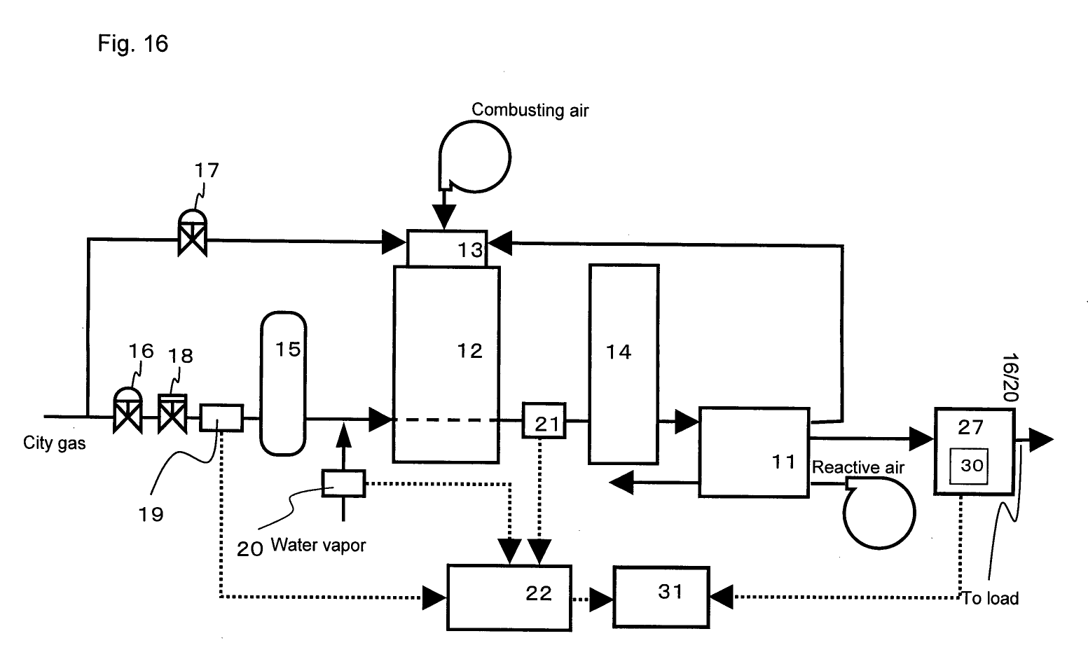

FIG. 16 is a configurational diagram illustrating the fuel cell power generation system according to Embodiment 8 of the present invention. However, where the components have the same members and function as those of FIG. 1, the same numbers are given and the description thereof will be omitted. The arrow represented by dotted line in FIG. 16 indicates the flow of signal detected or calculated.

The fuel system of the present embodiment further comprises an input current-controlling instrument 30 which controls the amount of current drawn from the fuel cell 11 by the DC-AC inverter 27 of supplying ac power from the fuel cell 11 to a load which is not shown and an inverter-controlling instrument 31 which controls the operation of the input current-controlling instrument 30 upon the reception of the degree of deterioration at the deterioration degree detecting unit 22 in addition to the constitution of the fuel cell power generation system of Embodiment 1 shown in FIG. 1. The input current-controlling instrument 30 and the inverter-controlling instrument 31 each are an example of the generated power output controlling instrument of the present invention.

In the fuel cell power generation system according to Embodiment 8, the stable operation of DC-AC inverter 27 can be assured by reducing the generated electric power output of the fuel cell 11 to cope with the fall off voltage of the fuel cell 11 deriving from the reduction of the content of hydrogen in the fuel gas caused by the deterioration of the reformer 12.

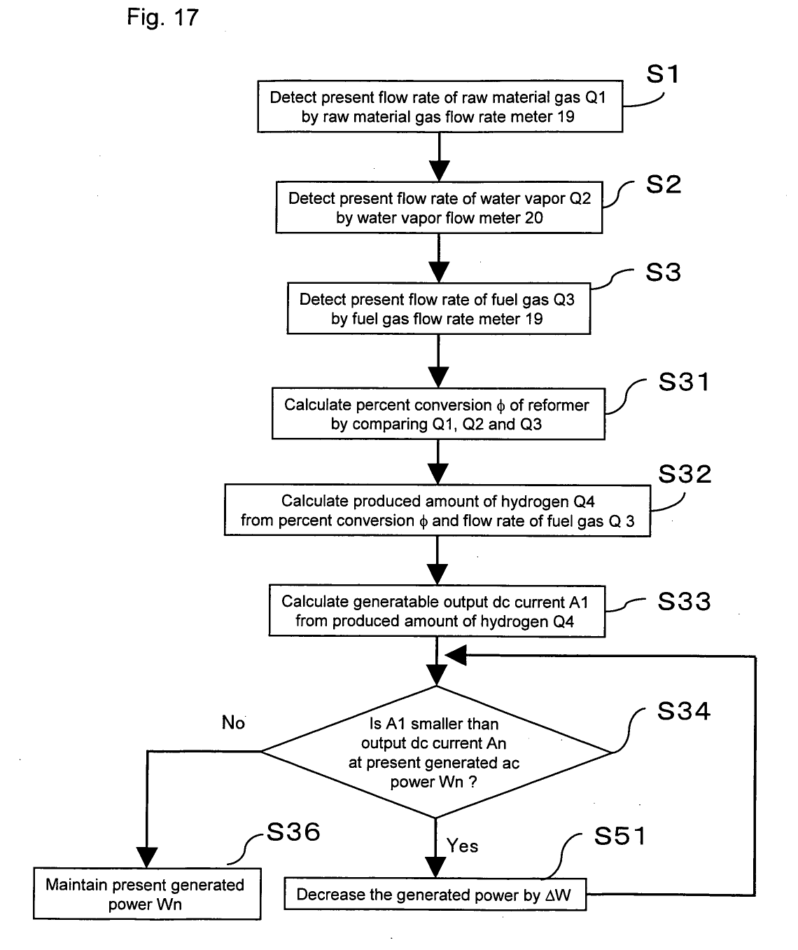

The operation of the reformer 12 of the fuel cell power generation system according to Embodiment 8 of reducing the generated power output from the fuel cell 11 upon the degree of deterioration of the reformer 12 will be described in connection with FIGS. 16 and 17. FIG. 17 is a flow chart illustrating the operating method to be used in the operation of reducing the generated electric power output from the fuel cell 11.

Steps S1 to S3 shown in FIG. 17 are the same as those of Embodiment 1 described in connection with FIG. 5, S31 is a step comprising S4 and S5 in combination, and S32 to S34 and S36 are as shown in the flow chart of FIG. 11 of Embodiment 5.

In other words, in the present embodiment, upon the reception of conversion ratio of methane φ as deterioration degree obtained at the deterioration degree judging unit 22 and the flow rate of fuel gas Q3, the inverter-controlling instrument 31 calculates the produced hydrogen amount Q4 which the reformer 12 can produce at present (S32). Further, the output dc current A1 which the fuel cell 11 can generate is calculated on the basis of this produced hydrogen amount Q4 (S33).

Further, judgment is made to see if A1 is smaller than the output dc current An at the present generated ac power Wn by referring to the operating conditions of DC-AC inverter 27 (S34). In the case where An is greater than A1, the inverter-controlling instrument 31 controls the inverter 27 so that the amount of current drawn from the fuel cell 11 by the input current-controlling instrument 30 of the inverter 27 is reduced (S51). The reduction of the amount of current from the fuel cell 11 causes the reduction of electric power which the fuel cell 11 outputs to DC-AC inverter 27. Further, the input current-controlling instrument 30 does not control the voltage of the fuel cell 11, but the voltage of the fuel cell 11 rises.

Accordingly, the voltage of the fuel cell 11 can be kept high while the electric power is reduced by reducing the current from the fuel cell 11.

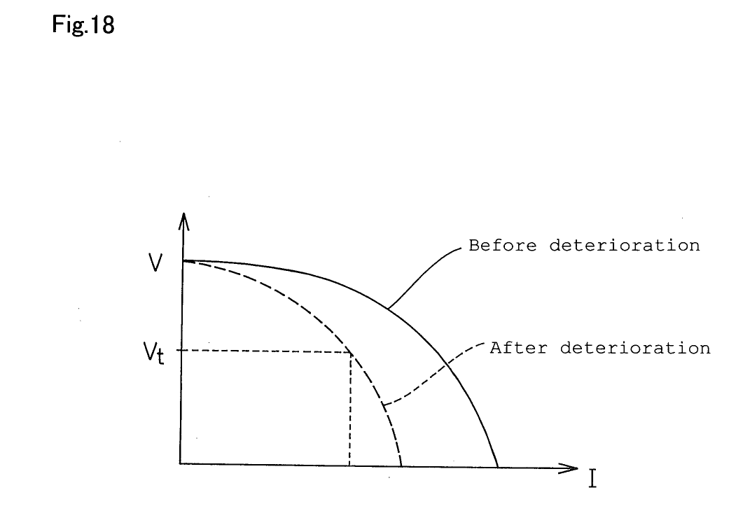

The fuel cell 11 can supply electric power even if the voltage thereof is lowered, but DC-AC inverter 27 which converts the electric power of the fuel cell and then supplies it to the load as ac power does not operate when the voltage thereof is not higher than a predetermined value. As shown in FIG. 18, due to percent conversion φ caused by the deterioration of the reformer 12, both the voltage and current which the fuel cell 11 can supply are deteriorated, and the amount of current corresponding to the lower limit of input voltage Vt at which DC-AC inverter 27 can operate, too, is lowered.

When the fuel gas supplied into the fuel cell 11 is constant, the amount of current corresponding to the lower limit of input voltage Vt is great before deterioration, but the necessary amount of current cannot be obtained as shown by the straight line represented by the dotted line in the graph after deterioration. When the supplied amount of fuel gas is raised, this problem can be solved, but the degree of deterioration of the reformer 12 increases and the supply of fuel gas while the conversion ratio of methane is deteriorated causes the waste of raw material gas and water vapor.

Therefore, the present embodiment is intended to make the use of the change of gradient of current-voltage curve with deterioration to lower the amount of current so that the voltage of the fuel cell can be kept not lower than the lower limit of input voltage Vt to prolong the time during which DC-AC inverter 27 can operate. The mount of current which can be drawn from the fuel cell 11 is lowered, and therefore the shortage for load has to be made up for by a systematic electric power which is not shown.

On the other hand, when An is not greater than A1, the inverter-controlling instrument 31 controls such that the operating conditions of the input current-controlling instrument 30 remain the same. The present generated ac power Wn is maintained (S36).

Thus, in accordance with the present embodiment, even when the reformer 12 is deteriorated, the system can be kept in operable conditions over an extended period of time even under the conditions that the raw material gas and water vapor are supplied in a constant amount by reducing the amount of power from the fuel cell 11.

While Embodiments 5 to 8 have been described with reference to the constitution of causing the fuel cell power generation system to operate fairly regardless of the degree of deterioration as a result of deterioration of the conversion ratio of methane of the reformer 12, these embodiments may be executed individually or in arbitrary combination.

A fuel cell power generation system comprising all the constitutions of Embodiments 5 to 8 will be described below as an example.

### EXAMPLE

The fuel cell power generation system of the present example is intended to stabilize the operation thereof by sequentially executing (1) the operation of Embodiment 5, (2) the operation of Embodiment 6, (3) the operation of Embodiment 7 and (4) the operation of Embodiment 8 when the deterioration degree detecting unit 22 detects the degree of deterioration of the reformer 12. In some detail, when the deterioration of the reformer is first detected, the operation of heating the reformer 12 of Embodiment 5 is executed, followed by the parallel execution of the above operations (2) to (4) while the heating operation is being executed on background.

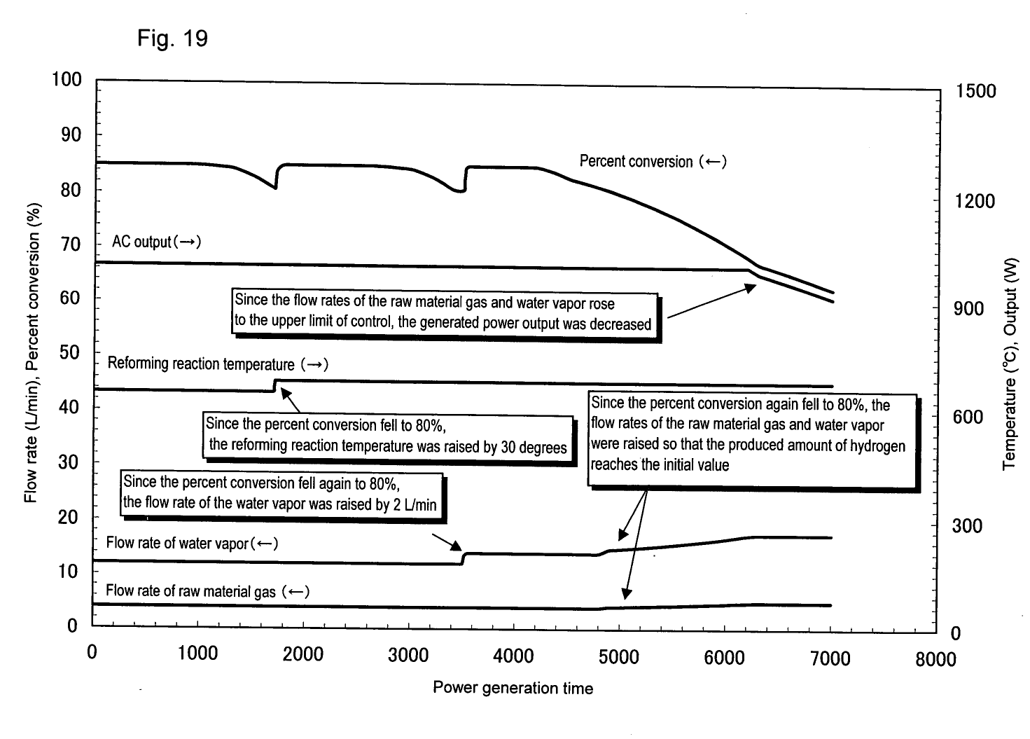

Continuous operation was performed using a fuel cell having a rated output of 1,000 W during normal operation. The transition of the flow rate per every power generation hour (L/min), the conversion ratio of methane (%), the temperature of the reformer 12 (° C.) and the output electric power (W) of the fuel cell 11 is shown graphically in FIG. 19.

Since the conversion ratio began to fall when the operating time reached 1,000 hours and then fell to close to 80% when the operating time reached 1,700 hours as shown in FIG. 19, the burner-controlling instrument 26 was used to control the burner 13 such that the caloric force of the burner 13 was raised to raise the reaction temperature of the reformer 12 by 30° C. as AT. In this manner, the percent conversion was recovered, making it possible to maintain all the flow rate of water vapor and raw material gas which are being supplied into the reformer 12 and the electric power output of the fuel cell 11 at the initial state during the starting of operation.

Subsequently, since the conversion ratio again fell to 80% when the operating time reached 3,400 hours, the flow rate control valve-controlling instrument 29 was used this time to control the flow rate control valve 28 so that the opening of the flow rate control valve 28 is raised to increase the flow rate of water vapor to the reformer 12 by 2 L/min as ΔQ2. In this manner, the conversion ratio was again recovered to the initial state, making it possible to maintain any of the flow rate of raw material gas supplied into the reformer 12 and the power output of the fuel cell 11 at the initial state during the starting of operation.

Further, since the conversion ratio again fell to 80% when the operating time reached 4,800 hours, the flow rate control valve-controlling instrument 29 was used this time to control the flow rate control valves 18 and 28 so that the opening of the flow rate control valves 18 and 28 is intermittently raised to increase the flow rate of water vapor and raw material gas to the reformer 12 little by little. In this manner, the generated amount of fuel gas is raised while suppressing drastic reduction of percent conversion, making it possible to maintain ac output at the initial state.

Moreover, since the upper limit at which the flow rate control valve-controlling instrument 29 can control was reached when the operating time reached 6,300 hours, the flow rate of water vapor and the supplied amount of raw material gas were fixed at maximum (water vapor: 5 L/min; raw material gas: 17.5 L/min) and the inverter-controlling instrument 31 controlled by the input current-controlling instrument 30 is controlled to decrease ac output from the fuel cell 11. The decrease of electric power is made up for by an external systematic electric power. When the conversion ratio finally falls below about 62%, the voltage of the fuel cell 11 is not greater than the lower limit of input voltage Vt at which DC-AC inverter 27 can operate and the operation of the system is suspended at about 7, 000 hours after starting.

### COMPARATIVE EXAMPLE

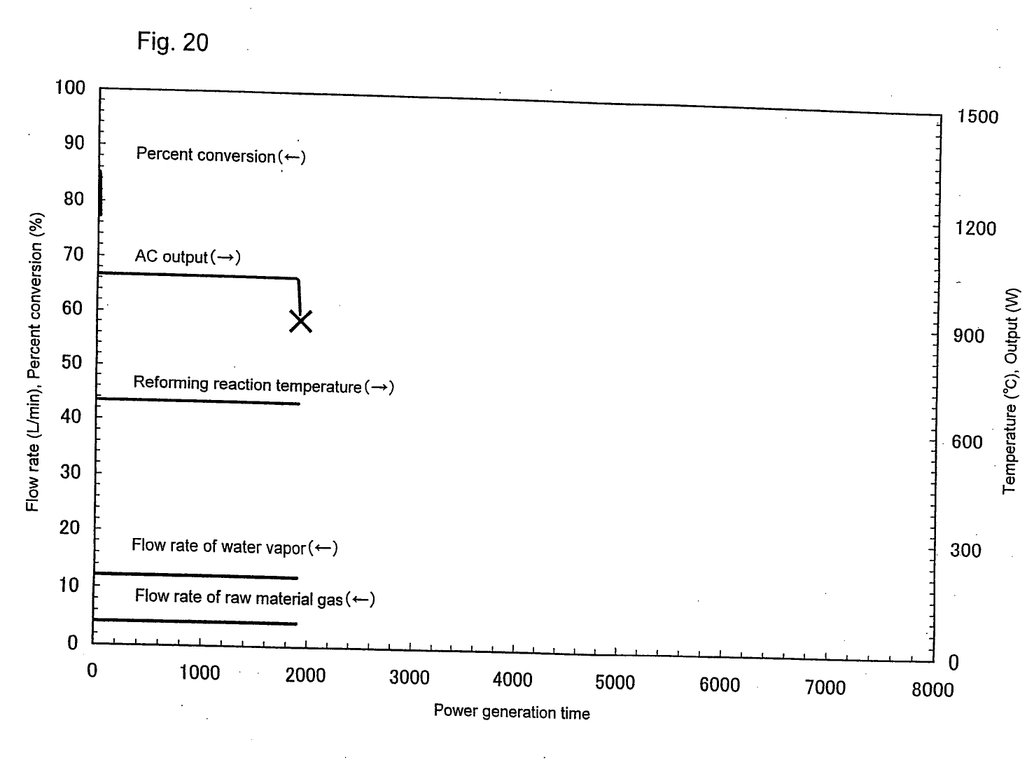

On the other hand, a fuel cell power generation system having the same constitution as Embodiment 1 but free of Embodiments 5 to 8 was prepared as a comparative example. Continuous operation was performed using a fuel cell having a rated output of 1,000 W during normal operation as a fuel cell 11 as in the above example. The transition of the flow rate per every power generation hour (L/min), the conversion ratio of methane (%), the temperature of the reformer 12 (° C.) and the output electric power (W) of the fuel cell 11 is shown graphically in FIG. 20.

As shown in FIG. 20, the conversion ratio began to fall when the operating time reached 1,000 hours and then reached close to 80% when the operating time reached 1,700 hours. When the operating time reached 1,800 hours, the output voltage of the fuel cell 11 began to fall, and when the conversion ratio then fell below about 77%, the voltage of the fuel cell 11 was not greater than the lower limit of input voltage Vt at which DC-AC inverter 27 can operate and the operation of system was suspended at about 1,900 hours after starting.

It was made obvious that the provision of a constitution comprising Embodiments 5 to 8 at the same time makes it possible to raise the operating time of the fuel cell power generation system. While it has been described that (1) the operation of Embodiment 5, (2) the operation of Embodiment 6, (3) the operation of Embodiment 7 and (4) the operation of Embodiment 8 are sequentially executed, the order of execution of these operations may be changed or any unnecessary operations may be omitted under some circumstances of operation. However, the order of execution of only the operation of Embodiment 6 and the operation of Embodiment 7 preferably remains the same.

The program according to the present invention may be a program cooperating with a computer of causing the function of all or some of units in the above-mentioned fuel cell power generation system of the present invention to be executed by the computer.

Further, the present invention may be a medium carrying a program of causing the function of all or some of units in the above-mentioned fuel cell power generation system of the present invention to be executed by a computer, wherein the program can be read by the computer and the program read cooperates with the computer to execute the above functions.

The term “some units” as used hereinabove is meant to indicate some of the plurality of units or some of the functions of one unit.

Further, a recording medium having a program of the present invention recorded thereon which can be read by a computer, too, is included in the present invention.

Further, one form of use of the program of the present invention may be an embodiment recorded in a computer-readable recording medium which cooperates with a computer.

Moreover, another form of use of the program of the present invention may be an embodiment which propagates through a transmitting medium, is read by a computer and cooperates with the computer.

Moreover, the recording media include ROM, etc. and the transmitting media include transmitting mechanisms such as internet, light, electric wave, sound wave, etc.

Further, the above-mentioned computer of the present invention is not limited to pure hardwares such as CPU but may be one comprising farm ware, OS and even periphery.

As mentioned above, the constitution of the present invention may be realized in the form of software or hardware.

A fuel cell power generation system and the method of detecting the degree of deterioration of the reformer therefor according to the present invention can detect the deterioration of the reformer of a fuel cell power generation system which operates with the temperature of reformed gas controlled at a constant value and is useful as a fuel cell power generation system and a method of detecting the deterioration of the reformer therefor, a fuel cell power generation method, etc.

1-19. (canceled)

20. A fuel cell power generation system comprising:
a reformer producing a hydrogen-rich fuel gas by reacting a raw material with water vapor;
a fuel cell generating power by using the fuel gas and an oxidizing gas;
a raw material flow rate detecting instrument which detects the flow rate of the raw material supplied into said reformer;
a water vapor flow rate detecting instrument which detects the flow rate of the water vapor supplied into the reformer;
a fuel gas flow rate detecting instrument which detects the flow rate of the fuel gas produced in said reformer; and
a deterioration degree detecting instrument which calculates the degree of deterioration of said reformer by comparing the calculated flow rate of the fuel gas calculated from the flow rate of the raw material and the flow rate of the water vapor with the detected flow rate of the fuel gas detected.

21. The fuel cell power generation system according to claim 20, wherein said deterioration degree detecting instrument calculates the flow rate of the fuel gas produced when said reformer is not deteriorated as the calculated flow rate.

22. A fuel cell power generation system comprising:
a reformer producing a hydrogen-rich fuel gas by reacting a raw material with water vapor;
a fuel cell generating power by using the fuel gas and an oxidizing gas;
a raw material flow rate detecting instrument which detects the flow rate of the raw material supplied into said reformer;
a water vapor flow rate detecting instrument which detects the flow rate of the water vapor supplied into said reformer;
a differential pressure detecting instrument which detects the difference of pressure of the fuel gas between two predetermined points on the flow path of the fuel gas; and
a deterioration degree detecting instrument which calculates the degree of deterioration of said reformer by comparing the calculated value of the difference of pressure of the fuel gas between the two predetermined points calculated from the flow rate of the raw material and the flow rate of the water vapor with the detected value of the difference of pressure of fuel gas between the two predetermined points.

23. A fuel cell power generation system according to claim 22, wherein said deterioration degree detecting instrument calculates the difference of pressure of the fuel gas produced when said reformer is not deteriorated between the two predetermined points as the calculated value.

24. A fuel cell power generation system comprising:
a reformer producing a hydrogen-rich fuel gas by reacting a raw material with water vapor;
a fuel cell generating power by using the fuel gas and an oxidizing agent gas;
a raw material flow rate detecting instrument which detects the flow rate of the raw material supplied into said reformer;
a water vapor flow rate detecting instrument which detects the flow rate of the water vapor supplied into said reformer;
a concentration detecting instrument which detects the concentration of water vapor or the concentration of raw material in the fuel gas; and
a deterioration degree detecting instrument which calculates the degree of deterioration of said reformer by comparing the calculated value of the concentration of water vapor contained in the fuel gas calculated from the flow rate of the raw material and the flow rate of the water vapor with the concentration of water vapor or the concentration of raw material detected.

25. A fuel cell power generation system according to claim 24, wherein said deterioration degree detecting instrument calculates the concentration of water vapor or the concentration of raw material contained in the fuel gas produced when said reformer is not deteriorated as the calculated value.

26. The fuel cell power generation system according to claim 20, further comprising a reformer heating instrument which raises the reaction temperature of said reformer according to the degree of deterioration detected by said deterioration degree detecting instrument so that the flow rate of the fuel gas is not less than a value at which power generation of said fuel cell is possible.

27. The fuel cell power generation system according to claim 22, further comprising a reformer heating instrument which raises the reaction temperature of said reformer according to the degree of deterioration detected by said deterioration degree detecting instrument so that the flow rate of the fuel gas is not less than a value at which power generation of said fuel cell is possible.

28. The fuel cell power generation system according to claim 24, further comprising a reformer heating instrument which raises the reaction temperature of said reformer according to the degree of deterioration detected by said deterioration degree detecting instrument so that the flow rate of the fuel gas is not less than a value at which power generation of said fuel cell is possible.

29. The fuel cell power generation system according to claim 20, further comprising a water vapor flow rate controlling instrument which controls the flow rate of the water vapor according to the degree of deterioration detected by said deterioration degree detecting instrument so that the flow rate of the water vapor increases to cause the flow rate of the fuel gas to be not less than a value at which power generation of said fuel cell is possible.

30. The fuel cell power generation system according to claim 22, further comprising a water vapor flow rate controlling instrument which controls the flow rate of the water vapor according to the degree of deterioration detected by said deterioration degree detecting instrument so that the flow rate of the water vapor increases to cause the flow rate of the fuel gas to be not less than a value at which power generation of said fuel cell is possible.

31. The fuel cell power generation system according to claim 24, further comprising a water vapor flow rate controlling instrument which controls the flow rate of the water vapor according to the degree of deterioration detected by said deterioration degree detecting instrument so that the flow rate of the water vapor increases to cause the flow rate of the fuel gas to be not less than a value at which power generation of said fuel cell is possible.

32. The fuel cell power generation system according to claim 29, further comprising a raw material flow rate controlling instrument which controls the flow rate of the raw material to increase according to the degree of deterioration detected by said deterioration degree detecting instrument so that the flow rate of the fuel gas is not less than a value at which power generation of said fuel cell is possible.

33. The fuel cell power generation system according to claim 30, further comprising a raw material flow rate controlling instrument which controls the flow rate of the raw material to increase according to the degree of deterioration detected by said deterioration degree detecting instrument so that the flow rate of the fuel gas is not less than a value at which power generation of said fuel cell is possible.

34. The fuel cell power generation system according to claim 31, further comprising a raw material flow rate controlling instrument which controls the flow rate of the raw material to increase according to the degree of deterioration detected by said deterioration degree detecting instrument so that the flow rate of the fuel gas is not less than a value at which power generation of said fuel cell is possible.

35. The fuel cell power generation system according to claim 20, further comprising a generated power output control instrument which controls the generated power output according to the degree of deterioration detected by said deterioration degree detecting instrument so that the generated power output decreases to not greater than a value at which power generation of said fuel cell is possible.

36. The fuel cell power generation system according to claim 22, further comprising a generated power output control instrument which controls the generated power output according to the degree of deterioration detected by said deterioration degree detecting instrument so that the generated power output decreases to not greater than a value at which power generation of said fuel cell is possible.

37. The fuel cell power generation system according to claim 24, further comprising a generated power output control instrument which controls the generated power output according to the degree of deterioration detected by said deterioration degree detecting instrument so that the generated power output decreases to not greater than a value at which power generation of said fuel cell is possible.

38. A fuel cell power generation system according to claim 24, wherein said water vapor concentration detecting instrument detects the water vapor concentration by detecting the dew point of the fuel gas flowing through the flow path of the fuel gas.

39. A fuel cell power generation system according to claim 24, wherein said water vapor concentration detecting instrument detects the water vapor concentration by detecting the relative humidity of the fuel gas flowing through the flow path of the fuel gas.

40. A fuel cell power generation system according to claim 24, wherein a water flow rate meter of measuring the amount of water which is supplied to produce the water vapor to be supplied into said reformer is provided instead of said water vapor flow rate detecting instrument, and said deterioration degree detecting instrument calculates the degree of deterioration of said reformer on the basis of the supplied amount of water measured by said water flow rate meter instead of the flow rate of the water vapor.

41. The fuel cell power generation system according to claim 20, comprising a life diagnosing instrument which determines the falling rate of the degree of deterioration based on the degree of deterioration of said reformer and the power generation time to calculate the period to reach the lower limit of the degree of deterioration of said reformer at which power generation of said fuel cell is made possible.

42. The fuel cell power generation system according to claim 22, comprising a life diagnosing instrument which determines the falling rate of the degree of deterioration based on the degree of deterioration of said reformer and the power generation time to calculate the period to reach the lower limit of the degree of deterioration of said reformer at which power generation of said fuel cell is made possible.

43. The fuel cell power generation system according to claim 24, comprising a life diagnosing instrument which determines the falling rate of the degree of deterioration based on the degree of deterioration of said reformer and the power generation time to calculate the period to reach the lower limit of the degree of deterioration of said reformer at which power generation of said fuel cell is made possible.

44. The fuel cell power generation system according to claim 20, wherein said deterioration degree detecting instrument uses conversion ratio of methane as the degree of deterioration of said reformer.

45. The fuel cell power generation system according to claim 22, wherein said deterioration degree detecting instrument uses conversion ratio of methane as the degree of deterioration of said reformer.

46. The fuel cell power generation system according to claim 24, wherein said deterioration degree detecting instrument uses conversion ratio of methane as the degree of deterioration of said reformer.

47. A method of detecting the degree of deterioration of a reformer of a fuel cell power generation system comprising:
a raw material flow rate detecting step of detecting the flow rate of a raw material supplied into said reformer which produces a hydrogen-rich fuel gas by reacting a raw material with water vapor;
a water vapor flow rate detecting step of detecting the flow rate of the water vapor supplied into said reformer;
a fuel gas flow rate detecting step of detecting the flow rate of the fuel gas produced in said reformer; and
a deterioration degree detecting step of calculating the degree of deterioration of said reformer by comparing the calculated flow rate of the fuel gas calculated from the flow rate of the raw material and the flow rate of the water vapor with the detected flow rate of the fuel gas detected.

48. A method of detecting the degree of deterioration of a reformer of a fuel cell power generation system comprising:
a raw material flow rate detecting step of detecting the flow rate of a raw material supplied into said reformer which produces a hydrogen-rich fuel gas by reacting a raw material with water vapor;
a water vapor flow rate detecting step of detecting the flow rate of the water vapor supplied into said reformer;
a fuel gas flow rate detecting step of detecting the flow rate of the fuel gas produced in said reformer;
a differential pressure detecting step of detecting the difference of pressure of the fuel gas between two predetermined points on the flow path of the fuel gas; and
a deterioration degree detecting step of calculating the degree of deterioration of said reformer by comparing the calculated value of the difference in pressure of the fuel gas between the two predetermined points calculated from the flow rate of the raw material and the flow rate of the water vapor with the detected value of the difference in pressure of fuel gas between the two predetermined points.

49. A method of detecting the degree of deterioration of a reformer of a fuel cell power generation system comprising:
a raw material flow rate detecting step of detecting the flow rate of the raw material supplied into said reformer which produces a hydrogen-rich fuel gas by reacting a raw material with water vapor;
a water vapor flow rate detecting step of detecting the flow rate of the water vapor supplied into the reformer;
a concentration detecting step of detecting the concentration of water vapor or the concentration of raw material in said fuel gas; and
a deterioration degree detecting step of calculating the degree of deterioration of the reformer by comparing the calculated value of the concentration of water vapor contained in the fuel gas calculated from the flow rate of the raw material and the flow rate of the water vapor with the detected water vapor concentration or the concentration of raw material concentration.

50. A fuel cell power generation method which executes power generation of a fuel cell using a fuel gas by making use of the method of detecting the degree of deterioration of the reformer of the fuel cell power generation system according to claim 47, comprising:
a reformer heating step of raising the reaction temperature of said reformer according to the degree of deterioration detected by said deterioration degree detecting step so that the flow rate of the fuel gas is not less than a value at which power generation of the fuel cell is made possible.

51. A fuel cell power generation method which executes power generation of a fuel cell using a fuel gas by making use of the method of detecting the degree of deterioration of the reformer of the fuel cell power generation system according to claim 48, comprising:
a reformer heating step of raising the reaction temperature of said reformer according to the degree of deterioration detected by said deterioration degree detecting step so that the flow rate of the fuel gas is not less than a value at which power generation of the fuel cell is made possible.

52. A fuel cell power generation method which executes power generation of a fuel cell using a fuel gas by making use of the method of detecting the degree of deterioration of the reformer of the fuel cell power generation system according to claim 49, comprising:
a reformer heating step of raising the reaction temperature of said reformer according to the degree of deterioration detected by said deterioration degree detecting step so that the flow rate of the fuel gas is not less than a value at which power generation of the fuel cell is made possible.

53. A fuel cell power generation method which executes power generation of a fuel cell using a fuel gas by making use of the method of detecting the degree of deterioration of the reformer of the fuel cell power generation system according to claim 47, comprising:
a water vapor flow rate controlling step of controlling the flow rate of the water vapor according to the degree of deterioration detected by said deterioration degree detecting step so that the flow rate of the water vapor increases to cause the flow rate of the fuel gas to be not less than a value at which power generation of said fuel cell is made possible.

54. A fuel cell power generation method which executes power generation of a fuel cell using a fuel gas by making use of the method of detecting the degree of deterioration of the reformer of the fuel cell power generation system according to claim 48, comprising:
a water vapor flow rate controlling step of controlling the flow rate of the water vapor according to the degree of deterioration detected by said deterioration degree detecting step so that the flow rate of the water vapor increases to cause the flow rate of the fuel gas to be not less than a value at which power generation of said fuel cell is made possible.

55. A fuel cell power generation method which executes power generation of a fuel cell using a fuel gas by making use of the method of detecting the degree of deterioration of the reformer of the fuel cell power generation system according to claim 49, comprising:
a water vapor flow rate controlling step of controlling the flow rate of the water vapor according to the degree of deterioration detected by said deterioration degree detecting step so that the flow rate of the water vapor increases to cause the flow rate of the fuel gas to be not less than a value at which power generation of said fuel cell is made possible.

56. A fuel cell power generation method which executes power generation of a fuel cell using fuel gas by making use of the method of detecting the degree of deterioration of the reformer of the fuel cell power generation system according to claim 47, comprising:
a raw material flow rate controlling step of controlling the flow rate of the raw material to increase according to the degree of deterioration detected by said deterioration degree detecting step so that the flow rate of the fuel gas is not less than a value at which power generation of said fuel cell is made possible.

57. A fuel cell power generation method which executes power generation of a fuel cell using fuel gas by making use of the method of detecting the degree of deterioration of the reformer of the fuel cell power generation system according to claim 48, comprising:
a raw material flow rate controlling step of controlling the flow rate of the raw material to increase according to the degree of deterioration detected by said deterioration degree detecting step so that the flow rate of the fuel gas is not less than a value at which power generation of said fuel cell is made possible.

58. A fuel cell power generation method which executes power generation of a fuel cell using fuel gas by making use of the method of detecting the degree of deterioration of the reformer of the fuel cell power generation system according to claim 49, comprising:
a raw material flow rate controlling step of controlling the flow rate of the raw material to increase according to the degree of deterioration detected by said deterioration degree detecting step so that the flow rate of the fuel gas is not less than a value at which power generation of said fuel cell is made possible.

59. A fuel cell power generation method of executing power generation of a fuel cell using the fuel gas by making use of the method of detecting the degree of deterioration of the reformer of the fuel cell power generation system according to claim 47, comprising:
a generated electric power output controlling step of controlling the generated power output according to the degree of deterioration detected by said deterioration degree detecting step so that the generated power output decreases to not greater than a value that allows power generation of said fuel cell.

60. A fuel cell power generation method of executing power generation of a fuel cell using the fuel gas by making use of the method of detecting the degree of deterioration of the reformer of the fuel cell power generation system according to claim 48, comprising:
a generated electric power output controlling step of controlling the generated power output according to the degree of deterioration detected by said deterioration degree detecting step so that the generated power output decreases to not greater than a value that allows power generation of said fuel cell.

61. A fuel cell power generation method of executing power generation of a fuel cell using the fuel gas by making use of the method of detecting the degree of deterioration of the reformer of the fuel cell power generation system according to claim 49, comprising:
a generated electric power output controlling step of controlling the generated power output according to the degree of deterioration detected by said deterioration degree detecting step so that the generated power output decreases to not greater than a value that allows power generation of said fuel cell.

62. A recording medium, which can be processed by a computer, having a program allowing a computer to perform as said deterioration degree detecting unit of the fuel cell power generation system according to claim 20 for calculating the degree of deterioration of said reformer by comparing the calculated flow rate of the fuel gas, calculated from the flow rate of the raw material and the flow rate of the water vapor, with the detected flow rate of the fuel gas.

63. A recording medium, which can be processed by a computer, having a program allowing a computer to perform as a deterioration degree detecting instrument of a fuel cell power generation system according to claim 22 for calculating the degree of deterioration of said reformer by comparing the calculated value of the difference in pressure of fuel gas between the two predetermined points calculated from the flow rate of the raw material and the flow rate of the water vapor with the detected value of the difference in pressure of the fuel gas between the two predetermined points.

64. A recording medium, which can be processed by a computer, having a program allowing a computer to perform as a deterioration degree detecting instrument of a fuel cell power generation system according to claim 24 for calculating the degree of deterioration of said reformer by comparing the calculated value of the concentration of water vapor or the concentration of the raw material contained in the fuel gas, calculated from the flow rate of the raw material and the flow rate of the water vapor, with the concentration of the detected water vapor.
